(19) United States
(12) Patent Application Publication
(10) Pub. No.: US 2025/0176061 A1
(43) Pub. Date: May 29, 2025

(54) MANAGING A SMALL DATA TRANSMISSION CONFIGURATION IN MOBILITY SCENARIOS

(71) Applicant: GOOGLE LLC, Mountain View, CA (US)

(72) Inventor: Chih-Hsiang Wu, Taoyuan City (TW)

(21) Appl. No.: 18/836,647

(22) PCT Filed: Feb. 10, 2023
(86) PCT No.: PCT/US23/12782

§ 371 Date: Aug. 7, 2024

Related U.S. Application Data
(60) Provisional application No. 63/267,923, filed on Feb. 11, 2022.

(51) Int. Cl. H04W 76/27; H04W 36/00; H04W 76/30

(52) U.S. Cl. CPC H04W 76/27; H04W 36/0033; H04W 76/30

(57) ABSTRACT

A method of managing configuration information for SDT operation is performed by a first RAN node. The method includes receiving an RRC message from a UE, receiving, from a second RAN node and during a handover procedure from the second RAN node to the first RAN node, an SDT configuration for use by a UE when the UE is operating in an RRC inactive state, and, after the handover procedure, communicating with the UE operating in the RRC inactive state based on a UE context of the UE.

### FIELD OF THE DISCLOSURE

This disclosure relates generally to wireless communications and, more particularly, to communication of uplink and/or downlink data between a user equipment (UE) and a radio access network (RAN) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer defines an RRC_IDLE state, in which a UE does not have an active radio connection with a base station; an RRC_CONNECTED state, in which the UE has an active radio connection with the base station; and an RRC_INACTIVE state that allows a UE to more quickly transition back to the RRC_CONNECTED state RAN-level base station coordination and RAN-paging procedures. In some cases, the UE in the RRC_INACTIVE state has only one, relatively small packet to transmit. For situations such as these, 3GPP is discussing a Small Data Transmission (SDT) procedure to enable the 5G NR (New Radio), a wireless communication standard, to support data transmission for the UE operating in the RRC_INACTIVE state (i.e., without requiring that the UE transition to the RRC_CONNECTED state).

SDT is enabled on a radio bearer basis and is initiated by the UE only if (1) the amount of uplink (UL) data awaiting transmission (across all radio bearers for which SDT is enabled) is below a configured threshold, (2) the downlink (DL) reference signal power (RSRP) is above a configured threshold, and (3) a valid SDT resource is available. An SDT procedure can be initiated by the UE with either a transmission over a random access channel (RACH), i.e., random access SDT (RA-SDT) or over Type 1 configured grant (CG) resources, i.e., CG-SDT. For the RA-SDT, the network configures 2-step and/or 4-step random access resources for SDT. In the RA-SDT, the UE can transmit an initial transmission including data in a message 3 (Msg3) of a 4-step random access procedure or in payload of a message A (MsgA) of a 2-step random access procedure. The network can then schedule subsequent uplink and/or downlink transmissions using dynamic uplink grants and downlink assignments, respectively, after the completion of the random access procedure.

The CG-SDT can only be initiated with valid UL timing alignment. The UE maintains the UL time alignment based on a network-configured, SDT-specific time alignment timer and DL RSRP of a configured number of highest ranked synchronization signal blocks (SSBs). Upon expiry of the SDT-specific time alignment timer, the CG resources are released. Upon initiating the CG-SDT, the UE transmits an initial transmission including data on a CG occasion using a CG configuration, and the network can schedule subsequent UL transmissions using dynamic grants on future CG resource occasions. During the CG-SDT, the DL transmissions are scheduled using dynamic assignments. The UE can initiate subsequent UL transmission only after receiving, from the network, confirmation of the initial UL transmission.

However, it is not clear how base stations of a RAN, including distributed base stations that include a central unit (CU) and at least one distributed unit (DU), manage SDT configuration(s) for a UE during handover procedures. Failure to properly manage SDT configurations during handover can result in data communication latency and/or other network inefficiencies.

### SUMMARY

In various implementations of this disclosure, a RAN node (e.g., a base station, or a CU of a distributed base station) performs operations to manage configuration(s) (e.g., an SDT configuration) for a UE.

In a first aspect of this disclosure, during a handover procedure or a UE context retrieval procedure in which a first RAN node is a target node and a second RAN node is a source node, the first RAN node discards at least a portion of an SDT configuration received from the second RAN node.

In some implementations, the first RAN node receives the SDT configuration and a UE context from the second RAN node, and discards the SDT configuration but retains the UE context for use when communicating with the UE. Alternatively, the first RAN node may discard only a portion of the SDT configuration (e.g., an SDT DU configuration) while retaining another portion of the SDT configuration (e.g., an SDT CU configuration).

In other implementations, the first RAN node receives handover preparation information including at least one non-SDT configuration and an SDT configuration for a UE, and discards the SDT configuration but retains the non-SDT configuration(s).

In a second aspect of this disclosure, during a handover procedure or a UE context retrieval procedure in which a first RAN node is a source node and a second RAN node is a target node, the first RAN node includes at least one non-SDT configuration in handover preparation information that the first RAN node sends to the second RAN node, but excludes an SDT configuration from the handover preparation information.

In a third aspect of this disclosure, a CU of a distributed base station transmits handover preparation information to a RAN node, with the handover preparation information excluding or including a configuration (e.g., an SDT configuration) based on whether the RAN node is a DU or is not a DU (e.g., is a CU or other base station), respectively.

In one aspect, a method of managing configuration information for SDT operation is performed by a first RAN node. The method includes receiving, from a second RAN node and during a handover procedure from the second RAN node to the first RAN node, an SDT configuration for use by a UE when the UE is operating in an inactive state. The method also includes discarding at least a portion of the SDT configuration, and after the handover procedure or UE context retrieval procedure, communicating with the UE operating in the inactive state.

In another aspect, a method of managing configuration information for SDT operation is performed by a first RAN node. The method includes communicating with a UE operating in an inactive state using an SDT configuration, transitioning the UE from the inactive state to a connected state, communicating with the UE operating in the connected state using a non-SDT configuration, and determining to hand over the UE to a second RAN node. The method also includes, in response to the determining, transmitting handover preparation information to the second RAN node, the handover preparation information including the non-SDT configuration and excluding the SDT configuration.

In another aspect, a method of managing configuration information is performed by a CU of a distributed base station in a RAN. The method includes communicating with a UE, and transmitting handover preparation information to a RAN node. When the RAN node is another base station or another CU, the handover preparation information includes a configuration for the UE to use when communicating with the RAN. When the RAN node is a DU, the handover preparation information excludes the configuration.

In one aspect, a method, performed by a first radio access network (RAN) node, of managing configuration information for small data transmission (SDT) operation, includes: receiving a radio resource control (RRC) message from a user equipment (UE); receiving, from a second RAN node and during a handover procedure from the second RAN node to the first RAN node, an SDT configuration for use by the UE when the UE is operating in an RRC inactive state; and, after the handover procedure, communicating with the UE operating in the RRC inactive state based on a UE context of the UE.

In another aspect, a method, performed by a first radio access network (RAN) node, of managing configuration information for small data transmission (SDT) operation, includes: communicating with a user equipment (UE) operating in a radio resource control (RRC) inactive state using an SDT configuration; transitioning the UE from the RRC inactive state to an RRC connected state; communicating with the UE operating in the RRC connected state using a non-SDT configuration; determining to hand over the UE to a second RAN node; and, in response to the determining, transmitting handover preparation information to the second RAN node, the handover preparation information excluding the SDT configuration.

### BRIEF DESCRIPTION OF THE DRAWINGS

FIG. 1A is a block diagram of an example wireless communication system in which a user device and a base station of this disclosure can implement the techniques of this disclosure, e.g., for reducing latency in data communication;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIGS. 3-6 illustrate several scenarios in which the devices of FIGS. 1A-2B can manage small data transmission configuration in mobility scenarios in accordance with the techniques of this disclosure; and

FIGS. 7-11 illustrate several methods, which can be implemented by one or more devices of FIGS. 1A-2B, for managing small data transmission configuration in mobility scenarios in accordance with the techniques of this disclosure.

### DETAILED DESCRIPTION OF THE DRAWINGS

As discussed in more detail below, a user equipment (UE) and/or a network node of a radio access network (RAN) can use the techniques of this disclosure for managing early data communication and transitioning a UE between states of a protocol for controlling radio resources between the UE and the RAN. As used in this disclosure, and unless the context clearly indicates a more specific meaning, small data communication can refer to small data transmission (SDT) from the perspective of the network (i.e., SDT in the downlink direction), or SDT from the perspective of the UE (i.e., SDT in the uplink direction).

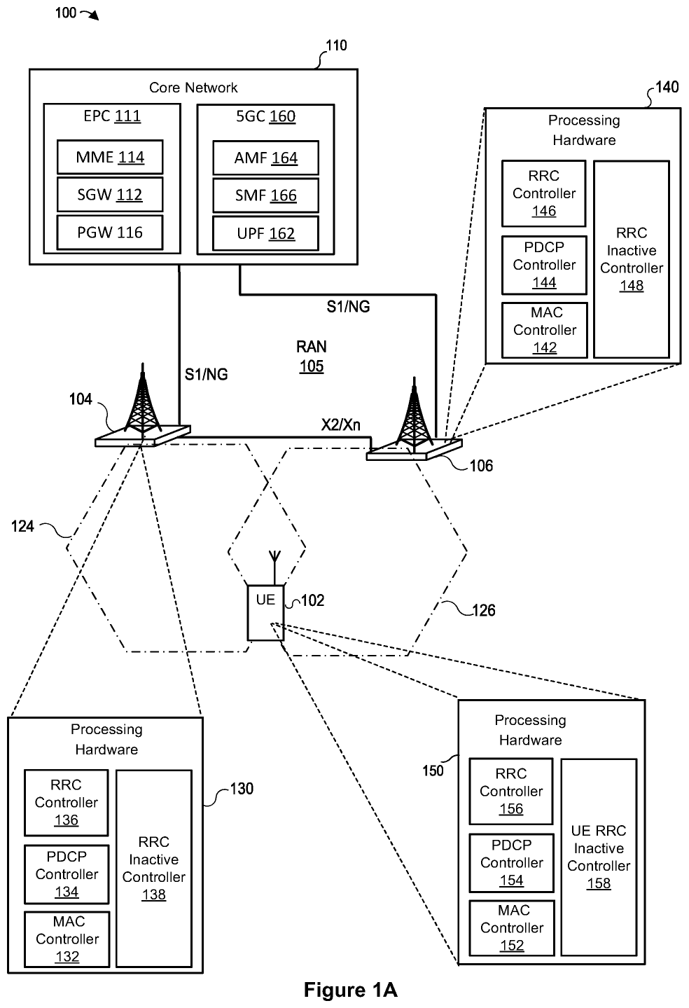

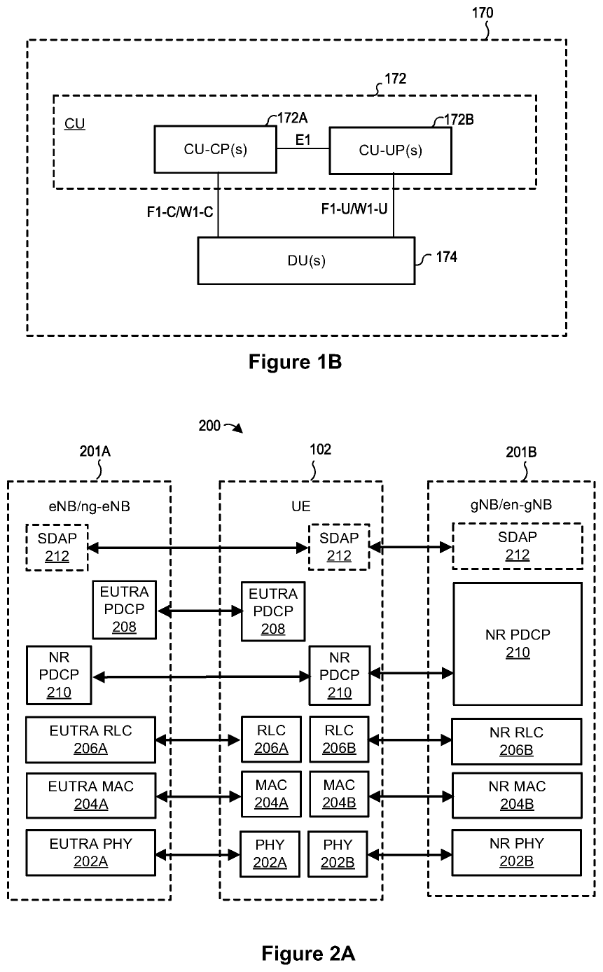

Referring first to FIG. 1A, an example wireless communication system 100 includes a UE 102, a base station (BS) 104, a base station 106, and a core network (CN) 110. The base stations 104 and 106 can operate in a RAN 105 connected to the CN 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB, the cell 124 is an evolved universal terrestrial radio access (E-UTRA) cell. Similarly, if the base station 106 is a gNB, the cell 126 is an NR cell, and if the base station 106 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 may utilize the techniques of this disclosure when the radio connection between the UE 102 and the RAN 105 is suspended, e.g., when the UE 102 operates in an inactive or idle state of the protocol for controlling radio resources between the UE 102 and the RAN 105. For clarity, the examples below refer to the RRC_INACTIVE or RRC_IDLE state of the RRC protocol.

As used herein, and unless a more specific meaning is indicated from the context of use, the term “data” or “data packet” can refer to signaling, control-plane information at a protocol layer of controlling radio resources (e.g., RRC), controlling mobility management (MM), controlling session management (SM), or non-signaling, non-control-plane information at one or more protocol layers above the layer of the protocol for controlling radio resources (e.g., RRC), above the layer of the protocol for controlling MM, above the layer of the protocol for controlling SM, and/or above the layer of the protocol for controlling quality of service (QOS) flows (e.g., service data adaptation protocol (SDAP)). The data to which the UE and/or the RAN applies the techniques of this disclosure can include, for example, Internet of Things (IoT) data, Ethernet traffic data, Internet traffic data, or a short message service (SMS) message. Further, as discussed below, the UE 102 in some implementations applies these techniques only if the size of the data is below a certain threshold value. It is also understood that, as used herein (and unless the context of its use indicates a more specific meaning), the term “configuration” can refer to a full configuration, or to a subset of parameters of a full configuration (e.g., a “delta” or other partial configuration that can augment an existing configuration without completely replacing the existing configuration).

In the example scenarios discussed below, the UE 102 transitions to the RRC_INACTIVE or RRC_IDLE state, selects a cell of the base station 104, and exchanges data with the base station 104, either via the base station 106 or with the base station 104 directly, without transitioning to the RRC_CONNECTED state. As a more specific example, after the UE 102 determines that data is available for UL transmission in the RRC_INACTIVE or RRC_IDLE state, the UE 102 can apply one or more security functions to a UL data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) for the UE 102 in the UL RRC message. The RAN 105 can identify the UE 102 based on the UE ID. In some implementations, the UE ID can be an inactive Radio Network Temporary Identifier (I-RNTI), a resume ID, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105 while in the RRC_INACTIVE or RRC_IDLE state.

In some implementations, the data is a UL service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may not include a UL RRC message in the UL MAC PDU. In this case, the UE 102 may not include a UE ID of the UE 102 in the UL MAC PDU not including a UL RRC message. In yet other implementations, the UE 102 can include the UL PDCP PDU in a UL RLC PDU and then include the UL RLC PDU in the UL MAC PDU. In some implementations where the UE 102 includes the UL RRC message in the UL MAC PDU, the UE 102 generates an RRC MAC-I and includes the RRC MAC-I in the UL RRC message. For example, the RRC MAC-I can be a resumeMAC-I field, as specified in 3GPP specification 38.331. In other implementations, the UE 102 can obtain the RRC MAC-I from the UL RRC message with an integrity key (e.g., K_{RRCint} key), an integrity protection algorithm, and parameters such as COUNT (e.g., 32-bit, 64-bit or 128-bit value), BEARER (e.g., 5-bit value) and DIRECTION (e.g., 1-bit value).

In other implementations, the data is a UL SDU of the NAS. The UE 102 applies the security function to the SDU and includes the secured SDU in a first UL PDU such as a NAS PDU, which can be associated with the NAS layer. For example, the NAS layer can be an MM sublayer or SM sublayer of 5G, Evolved Packet System (EPS), or 6G. The UE 102 can then include the UL NAS PDU in a second UL PDU such as a UL RRC message. Thus, the UE 102 in these cases transmits the (first) secured UL NAS PDU in the UL RRC message. In some implementations, the UE 102 can include the UL RRC message in a UL MAC PDU and transmit the UL MAC PDU to a base station (e.g., base station 104 or 106) via a cell (e.g., cell 124 or 126). In this case, the UE 102 may not include an RRC MAC-I in the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using encryption and/or integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. The base station 104 then retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an encryption and/or decryption key). If the security-protected packet is an integrity-protected packet, the integrity-protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. However, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU, and performs a retrieve UE context procedure with the base station 104 to obtain UE context information of the UE 102 from the base station 104. The base station 106 then derives at least one security key from the UE context information. Thereafter, the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an encryption and/or decryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieves the data from the security-protected packet, and sends the data to the CN 110 or edge server as described above.

Further, the RAN 105 in some implementations and scenarios transmits data in the DL direction to the UE 102 operating in the RRC_INACTIVE or RRC_IDLE state.

In one implementation, when the base station 104 determines that data is available for downlink transmission to the UE 102 currently operating in the RRC_INACTIVE or RRC_IDLE state, the base station 104 can apply at least one security function to the data to generate a security-protected packet, generate a first DL PDU including the security-protected packet, and include the first DL PDU in a second DL PDU. To secure the data, the base station 104 can apply the security function (e.g., integrity protection and/or encryption) to the DL data. More particularly, when integrity protection is enabled, the base station 104 can generate a MAC-I for protecting integrity of the data, so that the security-protected packet includes the DL data and the MAC-I. When encryption is enabled, the base station 104 can encrypt the data to generate an encrypted packet, so that the security-protected packet is an encrypted packet. Further, when both integrity protection and encryption are enabled, the base station 104 can generate a MAC-I for protecting the integrity of the data and encrypt the data along with the MAC-I to generate an encrypted packet and an encrypted MAC-I. The base station 104 in some implementations generates a first DL PDU, such as a DL PDCP PDU, using the security-protected packet, includes the first DL PDU in a second DL PDU associated with the MAC layer for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, includes the DL RLC PDU in the DL MAC PDU and transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second DL PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU that includes the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU), that includes the DL RLC PDU, and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response or a message B (MsgB) that the base station transmits in a random access procedure with the UE 102 before transmitting the DCI and scrambled CRC. In other implementations, the base station may assign the ID of the UE 102 to the UE 102 in an RRC message (e.g., RRC release message or an RRC reconfiguration message) that the base station transmits to the UE 102 before transmitting the DCI and scrambled CRC, e.g., while the UE 102 was in the RRC_CONNECTED state.

The UE 102 operating in the RRC_INACTIVE or RRC_IDLE state can receive the DCI and scrambled CRC on the PDCCH, and then confirm that a physical downlink shared channel (PDSCH), including the second DL PDU, is addressed to the UE 102 according to the ID of the UE 102, the DCI, and the scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. If the security-protected packet is both encrypted and integrity-protected, with encrypted data and an encrypted MAC-I, the UE 102 can decrypt the encrypted packet and encrypted MAC-I to obtain the data and the MAC-I. The UE 102 can then verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a MAC controller 132 configured to perform a random access procedure with one or more user devices, receive UL MAC protocol data units (PDUs) from one or more user devices, and transmit DL MAC PDUs to one or more user devices. The processing hardware 130 can also include a PDCP controller 134 configured to transmit and/or receive PDCP PDUs in accordance with the manner in which the base station 104 can transmit DL data and/or receive UL data. The processing hardware 130 further can include an RRC controller 136 to implement procedures and messaging at the RRC sublayer of the protocol communication stack. The processing hardware 130 in an example implementation includes an RRC inactive controller 138 configured to manage UL and/or DL communications with one or more UEs operating in the RRC_INACTIVE or RRC_IDLE state. The base station 106 can include generally similar components. In particular, components 140, 142, 144, 146, and 148 of the base station 106 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a MAC controller 152 configured to perform a random access procedure with a base station, transmit uplink MAC PDUs to the base station, and receive downlink MAC PDUs from the base station. The processing hardware 150 can also include a PDCP controller 154 configured to transmit and/or receive PDCP PDUs in accordance with the manner in which the UE 102 transmits UL data and/or receives DL data. The processing hardware further can include an RRC controller 156 to implement procedures and messaging at the RRC sublayer of the protocol communication stack.

FIG. 1B depicts an example distributed or disaggregated implementation of a base station 170, which may represent one or both of the base stations 104, 106. In this implementation, the base station 170 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include an RLC controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some implementations, the DU 174 operates as an (IAB)-node, and the CU 172 operates as an IAB-donor.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface. The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the connectivity between a CU-UP 172B and a DU 174 is established by the CU-CP 172A using Bearer Context Management functions.

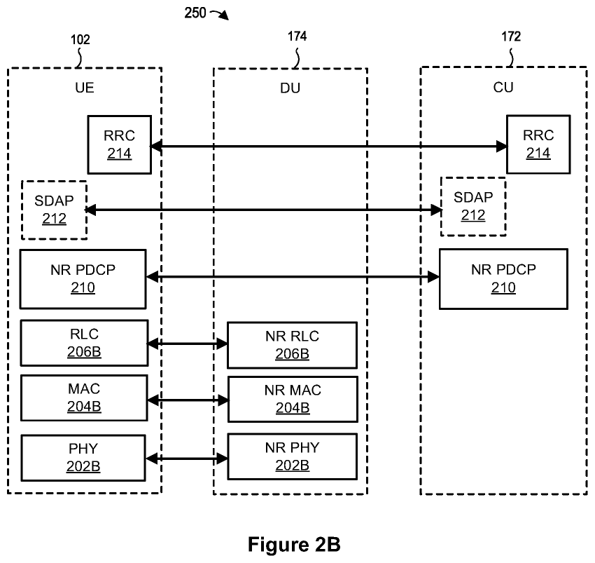

FIG. 2A illustrates, in a simplified manner, an example protocol stack 200 according to which the UE 102 can communicate with an eNB/ng-eNB 201A or a gNB 201B (e.g., one or both of the base stations 104, 106).

In the example stack 200, a PHY 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to SDAP 212 or an RRC sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as SDUs, and output packets (e.g., to the RLC layer 206A or 206B) that can be referred to as PDUs. Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or NAS messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

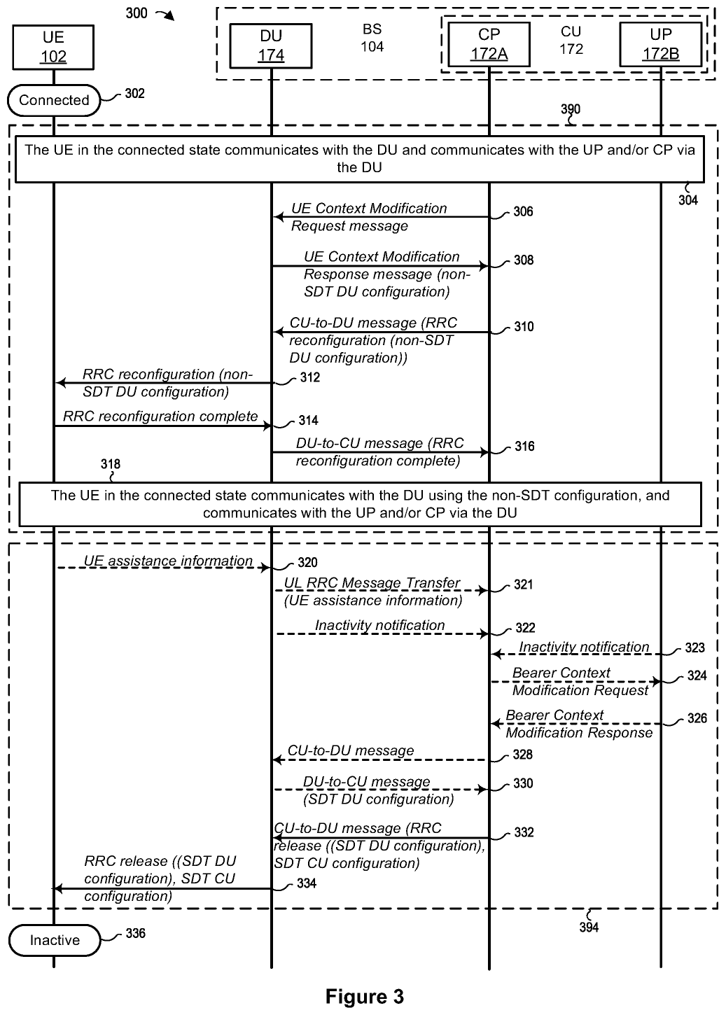

Next, several example scenarios that involve various components of FIG. 1A and relate to transmitting data in an inactive or idle state are discussed with reference to FIGS. 3-6. To simplify the following description, the “inactive state” can represent the RRC_INACTIVE or RRC_IDLE state, and the “connected state” can represent the RRC_CONNECTED state.

Referring first to FIG. 3, in a scenario 300, the base station 104 includes a CU 172 and a DU 174 and the CU 172 includes a CU-CP 172A and a CU-UP 172B. In this scenario 300, the UE 102 initially operates in a connected state 302 and communicates 304 with the DU 174, e.g., by using a DU configuration (i.e., a first non-SDT configuration), and communicates 304 with the CU-CP 172A and/or CU-UP 172B via the DU by using a CU configuration (i.e., a first non-SDT CU configuration). While the UE communicates 304 with the base station 104, the CU-CP 172A can send 306 a UE Context Modification Request message. In response, the DU 174 sends 308 a UE Context Modification Response message including a non-SDT configuration (i.e., a second non-SDT configuration) for the UE 102 to the CU-CP 172A. The CU-CP 172A generates a RRC reconfiguration message including the non-SDT DU configuration and transmits 310 a first CU-to-DU message (e.g., DL RRC Message Transfer message) including the RRC reconfiguration message to the DU 174. In turn, the DU 174 transmits 312 the RRC reconfiguration message to the UE 102. In response, the UE 102 transmits 314 an RRC reconfiguration complete message to the DU 174, which in turn transmits 316 a first DU-to-CU message (e.g., UL RRC Message Transfer message) including the RRC reconfiguration complete message to the CU-CP 172A.

After receiving 312 the RRC reconfiguration message, the UE 102 in the connected state communicates 318 with the DU 174 using the non-SDT DU configuration and communicates with the CU-CP 172A and/or CU-UP 172B via the DU. In cases where the RRC reconfiguration message does not include a CU configuration, the UE 102 communicates 318 with the CU-CP 172A and/or CU-UP 172B via the DU 174 using the first non-SDT CU configuration. In cases where the RRC reconfiguration message includes a non-SDT CU configuration (i.e., a second non-SDT CU configuration), the UE 102 communicates 318 with the CU-CP 172A and/or CU-UP 172B via the DU 174, using the second non-SDT CU configuration. In some implementations, the second non-SDT CU configuration can augment the first non-SDT CU configuration or include at least one new configuration parameter not included in the first non-SDT CU configuration. In such cases, the UE 102 and the CU-CP 172A and/or the CU-UP 172B can communicate 318 with one another using the second non-SDT CU configuration, and also using configuration parameters in the first non-SDT CU configuration that were not augmented by the second non-SDT CU configuration. In some implementations, the first non-SDT CU configuration includes configuration parameters related to operations of RRC and/or PDCP protocol layers (e.g., RRC 214 and/or NR PDCP 210), that the UE 102 and CU 172 use to communicate with one another while the UE 102 operates in the connected state. Similarly, the second non-SDT CU configuration can include configuration parameters related to operations of the RRC and/or PDCP protocol layers, that the UE 102 and CU 172 use to communicate with one another while the UE 102 operates in the connected state. In some implementations, the first non-SDT CU configuration includes configuration parameters in a RadioBearerConfig information element (IE) and/or MeasConfig IE as defined in 3GPP specification 38.331 v16.7.0. Similarly, the second non-SDT CU configuration can include configuration parameters in the RadioBearerConfig IE and/or MeasConfig IE as defined in 3GPP specification 38.331 v16.7.0. In some implementations, the first non-SDT CU configuration can be or include a RadioBearerConfig IE and/or a MeasConfig IE, and the second non-SDT CU configuration can be or include a RadioBearerConfig IE and/or MeasConfig IE.

In some implementations, the second non-SDT DU configuration can augment the first non-SDT DU configuration or include at least one new configuration parameter not included in the first non-SDT DU configuration. In such cases, the UE 102 and the DU 174 can communicate 318 with one another using the second non-SDT DU configuration and also using the configuration parameters in the first non-SDT DU configuration that were not augmented by the second non-SDT DU configuration. In some implementations, the first non-SDT DU configuration includes configuration parameters related to operations of RRC, RLC, MAC, and/or PHY protocol layers (e.g., RLC 206B, MAC 204B and/or PHY 202B), that the UE 102 and DU 174 use to communicate with one another while the UE 102 operates in the connected state. Similarly, the second non-SDT DU configuration can include configuration parameters related to operations of the RRC, RLC, MAC, and/or PHY protocol layers, that the UE 102 and DU 174 use to communicate with one another while the UE 102 operates in the connected state. In some implementations, the first non-SDT DU configuration includes configuration parameters in a CellGroupConfig IE as defined in 3GPP specification 38.331 v16.7.0. Similarly, the second non-SDT DU configuration can include configuration parameters in the CellGroupConfig IE as defined in 3GPP specification 38.331 v16.7.0. In some implementations, the first non-SDT DU configuration and the second non-SDT DU configuration can be CellGroupConfig IEs.

The events 306, 308, 310, 312, 314, 316 and 318 are collectively referred to in FIG. 3 as a non-SDT resource (re) configuration procedure 390, which can be optional.

While the UE 102 communicates with the base station 104 or after the non-SDT resource (re) configuration procedure 390 (if performed), the CU-CP 172A can determine to transition the UE 102 to an inactive state from the connected state, based on data inactivity of the UE 102 (i.e., based on the UE 102 in the connected state having no data activity with the base station 104). In some implementations, while the UE 102 communicates with the base station 104 or after the non-SDT resource (re) configuration procedure 390 (if performed), the UE 102 determines or detects data inactivity and transmits 320 to the DU 174, UE assistance information (e.g., a UEAssistanceInformation message) indicating that the UE 102 requests to transition to the inactive state with SDT configured. In turn, the DU 174 transmits 321 a UL RRC Message Transfer message including the UE assistance information to the CU-CP 172A. Thus, the CU-CP 172A can determine that the UE 102 is in data inactivity based on the UE assistance information. In other implementations, the DU 174 can perform data inactivity monitoring for the UE 102. The CU-CP 172A can transmit a CU-to-DU message (e.g., a UE Context Setup Request message or a UE Context Modification Request message) to the DU 174 to request or command the DU 174 to perform the data inactivity monitoring. In cases where the DU 174 detects or determines that the UE 102 is in data inactivity during the monitoring, the DU 174 can transmit 322 an inactivity notification (e.g., UE Inactivity Notification message) to the CU-CP 172A. Thus, the CU-CP 172A can determine that the UE 102 is in data inactivity based on the inactivity notification received from the DU 174. In yet other implementations, the CU-UP 172B can perform data inactivity monitoring for the UE 102. The CU-CP 172A can transmit a CP-to-UP message (e.g., a Bearer Context Setup Request message or a Bearer Context Modification Request message) to the CU-UP 172B to request or command the CU-UP 172B to perform the data inactivity monitoring. In cases where the CU-UP 172B detects or determines that the UE 102 is in data inactivity during the monitoring, the CU-UP 172B can transmit 323 an inactivity notification (e.g., Bearer Context Inactivity Notification message) to the CU-CP 172A. Thus, the CU-CP 172A can determine that the UE 102 is in data inactivity based on the inactivity notification received from the CU-UP 172B. In some implementations, the CU-CP 172A can determine that the UE 102 is in data inactivity based on the UE assistance information, the inactivity notification of the event 322, and/or the inactivity notification of the event 323.

After a certain period of data inactivity, the CU-CP 172A can determine that neither the CU 172 (i.e., the CU-CP 172A and/or the CU-UP 172B) nor the UE 102 has transmitted any data in the downlink direction or the uplink direction, respectively, during the certain period. In response to the determination, the CU-CP 172A can determine to transition the UE 102 to the inactive state with SDT configured. Alternatively, the CU-CP 172A can determine to transition the UE 102 to the inactive state without SDT configured in response to determining that the UE 102 is in data inactivity.

In response to or after determining that the UE 102 is in data inactivity (for the certain period) or determining to transition the UE 102 to the inactive state with SDT configured, the CU-CP 172A sends 324 to the CP-CU 172B a Bearer Context Modification Request message to suspend data transmission for the UE 102. In response, the CU-UP 172B suspends data transmission for the UE 102 and sends 326 a Bearer Context Modification Response message to the CU-CP 172A. In response to or after determining that the UE 102 is in data inactivity (for the certain period) or determining to transition the UE 102 to the inactive state with SDT configured, the CU-CP 172A in some implementations can send 328 a second CU-to-DU message (e.g., a UE Context Modification Request message) to instruct the DU 174 to provide an SDT DU configuration for the UE 102. In some implementations, the CU-CP 172A can include an SDT request indication (e.g., an IE such as a CG-SDT Query Indication IE) to request an SDT DU configuration in the second CU-to-DU message. In response to the SDT request indication or the second CU-to-DU message, the DU 174 can transmit 330 a second DU-to-CU message (e.g., UE Context Modification Response message) to the CU-CP 172A. Alternatively, the DU 174 does not include the SDT DU configuration in the second DU-to-CU message. Instead, the DU 174 sends to the CU-CP 172A an additional DU-to-CU message (e.g., UE Context Modification Required message) including the SDT DU configuration, after receiving the second CU-to-DU message or transmitting the second DU-to-CU message. The CU-CP 172A can transmit an additional CU-to-DU message (e.g., UE Context Modification Confirm message) to the DU 174 in response to the additional CU-to-DU message. In some alternative implementations, the CU-CP 172A can transmit the second CU-to-DU message and receive the second DU-to-CU message or the additional DU-to-CU message, before determining that the UE 102 is in data inactivity. In other alternative implementations, the CU-CP 172A can include the SDT request indication in the first CU-to-DU message of the event 308 and the DU 174 includes the SDT DU configuration in the first DU-to-CU message of the event 310 in response to the SDT request indication.

In response to determining to transition the UE 102 to the inactive state with SDT configured, the CU-CP 172A can generate an RRC release message (e.g., RRCRelease message or RRCConnectionRelease message) to transition the UE 102 to the inactive state. The CU-CP 172A can include the SDT DU configuration (if obtained from the DU 174) and/or an SDT CU configuration in the RRC release message. The CU-CP 172A then sends 332 to the DU 174 a third CU-to-DU message (e.g., a UE Context Release Command message, a UE Context Modification Request message or a DL RRC Message Transfer message), which includes the RRC release message. In turn, the DU 174 transmits 334 the RRC release message to the UE 102. In some implementations, the DU 174 generates a MAC PDU including the RRC release message and transmits 334 the MAC PDU to the UE 102. The RRC release message instructs the UE 102 to transition to the inactive state. The UE 102 transitions 336 to the inactive state from the connected state upon receiving the RRC release message. In response to the third CU-to-DU message, the DU 174 can retain the SDT DU configuration (if generated by the DU 174 during the procedure 328, 330) and may release or retain (a portion of) the first non-SDT DU configuration and/or (a portion of) the second non-SDT DU configuration. The DU 174 can send a third DU-to-CU message (e.g., a UE Context Release Complete message or a UE Context Modification Response message) to the CU-CP 172A in response to the third CU-to-DU message.

The UE 102 monitors a PDCCH using a C-RNTI to receive a DCI, while operating 302 in the connected state. In response to or after receiving 334 the RRC release message, the UE 102 stops using the C-RNTI to monitor a PDCCH. In some implementations, the UE 102 may retain the C-RNTI in response to or after receiving 334 the RRC release message or transitioning 336 to the inactive state from the connected state. In some implementations, the UE 102 performs a two-step or a four-step random access procedure with the base station 104 (e.g., the CU-CP 172A and/or DU 174) and receives from the DU 174 a random access response message including the C-RNTI in the random access procedure. In other implementations, the UE 102 receives a RRC message (e.g., RRC reconfiguration message) including the C-RNTI from the CU-CP 172A via the DU 174 or from another base station (e.g., base station 106) not shown in FIG. 3.

The events 320 (optional), 321 (optional), 322 (optional), 323, 324, 326, 328, 330, 332, and 334 are collectively referred to in FIG. 3 as an SDT configuration procedure 394.

In some implementations, the UE 102 releases the first non-SDT DU configuration and/or second non-SDT DU configuration or at least a portion of the first non-SDT DU configuration and at least a portion of the second non-SDT DU configuration, in response to the RRC release message. In other implementations, if the RRC release message instructs the UE 102 to transition to the inactive state (i.e., RRC_IDLE), the UE 102 releases the first non-SDT DU configuration and/or second non-SDT configuration. In still other implementations, if the RRC release message instructs the UE to transition to the inactive state (i.e., RRC_INACTIVE), the UE 102 releases a first portion of the first and/or second non-SDT DU configurations and retains a second portion of the first and/or second non-SDT DU configurations.

In some implementations, the CU-CP 172A does not include an indication in the third CU-to-DU message to instruct the DU 174 to retain the SDT DU configuration, and the DU 174 retains the SDT DU configuration as described above. In other implementations, the CU-CP 172A can include an indication in the third CU-to-DU message (e.g., a UE Context Release Command message) to instruct the DU 174 to retain the SDT DU configuration, and the DU 174 retains the SDT DU configuration in response to the indication. If the UE Context Release Command message excludes the indication, the DU 174 releases the SDT DU configuration. In yet other implementations, the CU-CP 172A does not include an indication in the third CU-to-DU message (e.g., a UE Context Modification Request message or a DL RRC Message Transfer message) for the UE 102 to instruct the DU 174 to release the SDT DU configuration. Thus, the DU 174 retains the SDT DU configuration in response to the third CU-to-DU message excluding the indication. If the third CU-to-DU message includes the indication, the DU 174 releases the SDT DU configuration.

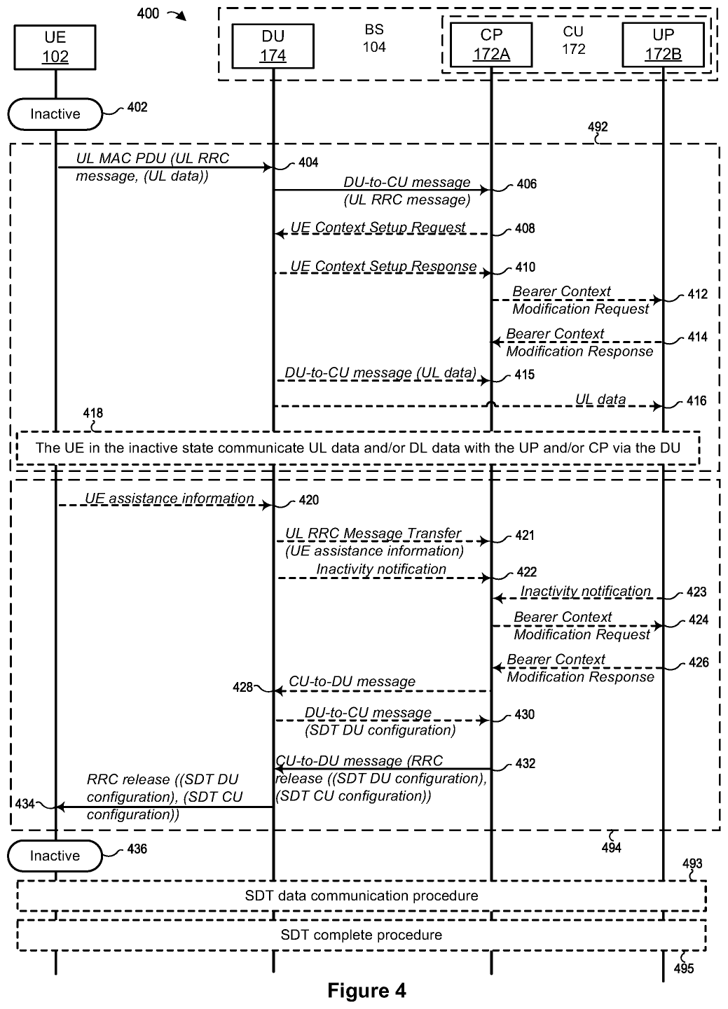

In some implementations, the parameters in the SDT CU configuration (e.g., SDT-Config IE) includes a DRB list (e.g., a std-DRB-List) including a list of DRB ID(s) indicating ID(s) of DRB(s) configured for SDT. In some implementations, the parameters in the SDT CU configuration can include an SRB2 indication (e.g., sdt-SRB2-Indication) indicating a SRB2 configured for SDT. In some implementations, the parameters in the SDT CU configuration can include a compression protocol continue indication (e.g., sdt-DRB-ContinueROHC) indicating whether a PDCP entity for the DRB(s) configured for SDT, during SDT operation (i.e., initial and/or subsequent SDT described in FIG. 4) continues. For example, the compression protocol can be a RObust Header Compression (ROHC). In some implementations, the SDT CU configuration can include a data volume threshold (e.g., sdt-DataVolumeThreshold) for the UE 102 to determine whether the UE 102 can initiate SDT. The CU-CP 172A can include the SDT DU configuration in the SDT CU configuration. The “SDT CU configuration” may also be referred to simply as “SDT configuration”.

In some implementations, the SDT DU configuration includes at least one of a buffer status reporting (BSR) configuration, a power headroom reporting (PHR) configuration, and/or CG-SDT configuration(s). The CG-SDT configuration(s) can include or be one or more CG configurations for CG-SDT, a DL bandwidth part (BWP) configuration for CG-SDT, a time alignment timer value for CG-SDT (e.g., CG-SDT time alignment timer value), and/or a timing advance validity threshold for CG-SDT. The DU 174 configures the timing advance validity threshold (e.g., including an RSRP range) for the UE 102 to determine whether the UE 102 can initiate SDT using the configured grant configuration for CG-SDT as described for FIG. 4. In accordance with the timing advance validity threshold, the UE 102 can evaluate whether a stored timing advance value is still valid. If the UE 102 determines that the stored timing advanced value is invalid, the UE 102 can initiate a RA-SDT with the CU 172 via the DU 174 as described for FIG. 4. In some implementations, the SDT DU configuration can be a SDT-MAC-PHY-CG-Config IE or SDT-MAC-PHY-Config 1E.

In some implementations, the DU 174 can start or restart a DU CG-SDT timer in response to or after receiving the SDT request indication, generating the CG-SDT configuration(s), receiving 328 the second CU-to-DU message, transmitting 330 the CG-SDT configuration(s) to the CU 172, receiving 332 the third CU-to-DU message, or transmitting 334 the CG-SDT configuration(s) to the UE 102. In some implementations, the DU 174 can start or restart the DU CG-SDT timer with a timer value to manage the CG-SDT configuration(s). In some implementations, the timer value is the same as the CG-SDT time alignment timer value. In other implementations, the timer value is close to the CG-SDT time alignment timer value. For example, the timer value can be larger than and close to the CG-SDT time alignment timer value. In another example, the timer value can be smaller than and close to the CG-SDT time alignment timer value. If and when the DU CG-SDT timer expires, the DU 174 releases the CG-SDT configuration(s). When or after releasing the CG-SDT configuration(s), the DU 174 refrains from receiving PUSCH transmissions from the UE 102 on the radio resources that were reserved or configured for the CG-SDT configuration(s). When or after releasing the CG-SDT configuration(s), the DU 174 can schedule transmissions for other UE(s) on the radio resources that were reserved or configured for the CG-SDT configuration(s).

As described above, the RRC release message 334 in some implementations can include the CG-SDT configuration(s). The UE 102 can start or restart a UE CG-SDT timer (e.g., CG-SDT time alignment timer (CG-SDT-TAT)) in response to or after receiving the CG-SDT configuration(s). In some implementations, the UE 102 can start or restart the UE CG-SDT timer with the CG-SDT time alignment timer value. If and when the CG-SDT timer expires, the UE 102 releases the CG-SDT configuration(s). When or after releasing the CG-SDT configuration(s), the UE 102 refrains from transmitting PUSCH transmissions on the radio resources that were reserved or configured for the CG-SDT configuration(s).

In some implementations, the DU 174 reserves radio resources configured in the configured grant configuration(s). In some implementations, the DU 174 releases the radio resources when releasing the SDT DU configuration or the CG-SDT configuration(s). In cases where the DU 174 does not provide the CG-SDT configuration(s) or the SDT DU configuration to the CU-CP 172A, the DU 174 releases all signaling and user data transport resources for the UE 102 in response to the third CU-to-DU message. In cases where the DU 174 provides the SDT DU configuration or the CG-SDT configuration(s) to the CU-CP 172A, the DU 174 retains signaling and user data transport resources for the UE 102 in response to or after receiving the third CU-to-DU message.

In cases where the SDT DU configuration does not include a configuration for CG-SDT, the CU-CP 172A and/or the DU 174 only configures RA-SDT for the UE 102. In such cases, the UE 102 can perform RA-SDT with the CU 172 via the DU 174 as described for FIG. 4.

In some implementations, the CU-CP 172A may not request the DU 174 to provide an SDT DU configuration when determining to transition the UE 102 to the inactive state with SDT configured. In such cases, the events 328 and 330 can omitted, and the CU-CP 172A does not include the SDT DU configuration in the RRC release message. Alternatively, the CU-CP 172A may generate the SDT DU configuration by itself (without requesting that the DU 174 provide an SDT DU configuration), and include the SDT DU configuration in the RRC release message.

In some implementations, the DU 174 does not include an SDT DU configuration in the second DU-to-CU message, e.g., if or because the UE 102 does not support CG-SDT, the DU 174 does not support CG-SDT or the DU 174 does not have available radio resources for CG-SDT. In such cases, the RRC release message does not include a SDT DU configuration. Otherwise, the DU 174 can transmit an SDT DU configuration to the CU-CP 172A as described above. In some implementations, the DU 174 may not include a configuration for CG-SDT in the SDT DU configuration in the second DU-to-CU message, e.g., if or because the UE 102 does not support CG-SDT, the DU 174 does not support CG-SDT or the DU 174 does not have available radio resources for CG-SDT. In such cases, the SDT DU configuration does not include a CG-SDT configuration. Otherwise, the DU 174 can include the CG-SDT configuration(s) in the SDT DU configuration as described above.

In some implementations, the CU-CP 172A may request the DU 174 to provide an SDT DU configuration as described above, in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. The CU-CP 172A can receive a UE capability (e.g., UE-NR-Capability IE) of the UE 102 from the UE 102, the CN 110 (e.g., MME 114 or AMF 164) or the base station 106, while the UE operates 302 in the connected state. The UE capability indicates whether the UE 102 supports CG-SDT. Thus, the CU-CP 172A can determine whether the UE supports CG-SDT in accordance with the UE capability. In some implementations, the CU-CP 172A can receive from the DU 174 a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 may determine whether to provide an SDT DU configuration for the UE 102 to the CU-CP 172A, depending on whether the UE 102 supports CG-SDT or not. In addition to whether the UE 102 supports CG-SDT or not, the DU 174 may additionally determine whether to provide an SDT DU configuration for the UE 102 to the CU-CP 172A, depending on whether the DU 174 supports CG-SDT or not. In cases where the UE 102 supports CG-SDT and/or the DU 174 supports CG-SDT, the DU 174 provides an SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the SDT DU configuration in the second DU-to-CU message). The DU 174 can receive the UE capability from the CU-CP 172A, while the UE operates 302 in the connected state or in the inactive state before the event 302. Thus, the DU 174 can determine whether the UE supports CG-SDT in accordance with the UE capability. In some implementations, the DU 174 can send a DU-to-CU message to the CU-CP 172A to indicate whether the DU 174 supports or does not support CG-SDT, as described above.

Referring now to FIG. 4, a scenario 400 depicts small data transmission. In the scenario 400, the base station 104 includes a CU 172 and a DU 174. The CU 172 includes a CU-CP 172A and a CU-UP 172B. In the scenario 400, the UE 102 initially operates 402 in an inactive state with SDT configured. In some implementations or scenarios, the UE 102 can transition to the inactive state with SDT configured from the connected state as described for FIG. 3. In such implementations, the UE 102 can receive a first SDT CU configuration and/or a first SDT DU configuration in a RRC release message (e.g., event 334). In other implementations or scenarios, the UE 102 can transition to the inactive state with SDT configured from the inactive state without SDT configured. For example, the UE 102 can receive from a base station (e.g., the base station 104 or base station 106) an RRC release message that transitions the UE 102 to the inactive state but does not configure SDT (e.g., indicating releasing SDT or not including a SDT configuration in the RRC release message). In this case, the UE 102 transitions to the inactive state without SDT configured in response to the RRC release message. The UE 102 in the inactive state with or without SDT configured may perform a RAN notification area (RNA) update with the base station without state transitions. During the RNA update, the UE 102 receives another RRC release message including a first SDT CU configuration and/or a first SDT DU configuration from the base station, similar to the RRC release message of the event 334.

Later in time, the UE 102 operating in the inactive state with SDT configured initiates SDT. In response to or after initiating SDT, the UE 102 generates an initial UL MAC PDU, which includes a UL RRC message and transmits 404 the initial UL MAC PDU to the DU 174 on the cell 124. The UE 102 may start an SDT session timer in response to initiating the SDT. In some implementations, the SDT session timer can be a new timer defined in a RRC specification (e.g., v17.0.0). The DU 174 retrieves the UL RRC message from the initial UL MAC PDU, generates a first DU-to-CU message including the UL RRC message, and sends 406 the first DU-to-CU message to the CU-CP 172A. In some implementations, the first DU-to-CU message can be an Initial UL RRC Message Transfer message. In other implementations, the first DU-to-CU message can be a UL RRC Message Transfer message.

In scenarios in which the UE 102 initiates SDT to transmit UL data (e.g., a data packet) qualifying for SDT, the UE 102 includes the UL data in the initial UL MAC PDU that the UE 102 transmits 404. In scenarios in which the UE 102 initiates SDT to receive DL data, the UE 102 does not include a UL data packet in the initial UL MAC PDU that the UE 102 transmits 404. The UE 102 can initiate SDT to receive DL data in response to receiving a paging from the DU 174. In such scenarios, the UE 102 can include an SDT indication in the initial UL MAC PDU or the UL RRC message to indicate to the base station 104 that the UE 102 is initiating SDT to receive DL data.

In some implementations, the UE 102 in the inactive state performs a random access procedure with the DU 174 to transmit 404 the UL MAC PDU. In such cases, the SDT can be a RA-SDT. For example, the random access procedure can be a four-step random access procedure or a two-step random access procedure. In the case of the four-step random access procedure, the UE 102 transmits a random access preamble to the DU 174 and, in response, the DU 174 transmits to the UE 102 a random access response (RAR) including an uplink grant, a temporary C-RNTI and a timing advance command, and the UE 102 transmits 404 the UL MAC PDU in accordance with the uplink grant. The DU 174 receives 404 the UL MAC PDU in accordance with the uplink grant in the RAR. In the case of the two-step random access procedure, the UE 102 transmits 404 to the DU 174 a message A (MsgA) including a random access preamble and the UL MAC PDU in accordance with two-step random access configuration parameters. The UE 102 can receive a message B (MsgB) including a temporary C-RNTI and a timing advance command from the DU 174 in response to the MsgA. The UE 102 receives the two-step random access configuration parameters in system information broadcast by the DU 174 on the cell 124 before transmitting 404 the UL MAC PDU. The DU 174 receives 404 the UL MAC PDU in accordance with the two-step random access configuration parameters.

When the UE 102 succeeds a contention resolution in the random access procedure, the UE 102 discards a previously retained C-RNTI (e.g., described for FIG. 3) and determines the temporary C-RNTI to be a particular C-RNTI (i.e., a new C-RNTI). The UE 102 monitors a PDCCH from the DU 174 using the C-RNTI to communicate 418 data with the DU 174. More specifically, the UE 102 receives a DCI and a CRC of the DCI on a PDCCH from the DU 174 and verifies the CRC using the C-RNTI. The DCI can include an uplink grant or a downlink assignment. If the UE 102 verifies the CRC is correct and the DCI includes an uplink grant, the UE 102 uses the uplink grant to transmit 418 UL data to the DU 174. If the UE 102 verifies the CRC is correct and the DCI includes a downlink assignment, the UE 102 uses the downlink assignment to receive 418 DL data from the DU 174.

In other implementations, the UE 102 can transmit 404 the UL MAC PDU on radio resources configured in a CG configuration for SDT (i.e., a CG-SDT configuration) in cases where the UE 102 received such a configuration as described for FIG. 3. Thus, the DU 174 receives 404 the UL MAC PDU on the radio resources.

In some implementations, the UE 102 can transmit 418 subsequent UL MAC PDU(s), including one or more UL data packets, on radio resources configured in the CG configuration. In some implementations, the UE 102 can transmit 418 the subsequent UL MAC PDU (s,) on radio resources configured in uplink grant(s) received on PDCCH(s) from the DU 174. In some implementations, the UE 102 can transmit 418 some of the subsequent UL MAC PDU(s) on radio resources configured in the CG configuration and transmit 418 the other of the subsequent UL MAC PDU(s) on radio resources configured in the uplink grant(s).

If the UE 102 includes UL data in the initial UL MAC PDU, the DU 174 retrieves the UL data from the initial UL MAC PDU. In such cases, the DU 174 can include the UL data in the DU-to-CU message of the event 406. Alternatively, the DU 174 can send 415 a DU-to-CU message including the UL data to the CU-CP 172A. In this alternative, the UL data can include or be a PDCP PDU, an RRC PDU, an NAS PDU, or an LTE positioning protocol (LPP) PDU. The PDCP PDU can include a RRC PDU. As yet another alternative, the DU 174 can send 416 the UL data to the CU-UP 172B separately via a user-plane (UP) connection as described below. In this alternative, the UL data can include or be a PDCP PDU and the PDCP PDU can include an SDAP PDU, an IP packet, or an Ethernet packet.

After receiving 406 the first DU-to-CU message, the CU-CP 172A in some implementations can send 408 a UE Context Setup Request message to the DU 174 to establish a UE Context of the UE 102 at the DU 174. In the UE Context Setup Request message, the CU-CP 172A can include transport layer information for one or more GTP-U tunnels between the CU-UP 172B and DU 174 so that the DU 174 can transmit the UL data and/or subsequent UL data (e.g., in small data communication 418) via the one or more GTP-U tunnels to the CU-UP 172B. In response, the DU 174 can send 410 a UE Context Setup Response message to the CU-CP 172A. After receiving 406 the first DU-to-CU message, transmitting 408 the UE Context Setup Request message or receiving 410 the UE Context Setup Response message, the CU-CP 172A transmits 412 to the CU-UP 172B a Bearer Context Modification Request message to resume data transmission for the UE 102. In response, the CU-UP 172B resumes data transmission for the UE 102 and transmits 414 a Bearer Context Modification Response message to the CU-CP 172A. After receiving 408 the UE Context Setup Request message or transmitting 410 the UE Context Setup Response message, the DU 174 can transmit 415 the DU-to-CU message including the UL data to the CU-CP 172A, in cases where the UL data of the event 404 includes a RRC message or is associated with a SRB (e.g., SRB1 or SRB2). In cases where the UL data associated with a DRB, the DU 174 can transmit 416 the UL data to the CU-UP 172B.

In some implementations, the CU-CP 172A can include transport layer information of the CU-UP 172B in the UE Context Setup Request message. The transport layer information of the CU-UP 172B can include an IP address and/or an uplink tunnel endpoint ID (e.g., TEID). The DU 174 can transmit 416 the UL data to the CU-UP 172B using the transport layer information of the CU-UP 172B. In cases where the UE 102 has subsequent UL data (e.g., one or more UL data packets) to transmit, the UE 102 can transmit 418 one or more subsequent UL MAC PDUs including the subsequent UL data to the DU 174. In turn, the DU 174 retrieves the subsequent UL data from the subsequent UL MAC PDU(s). In cases where the subsequent UL data is associated with one or more SRB (e.g., SRB1 and/or SRB2), the DU 174 transmits 418 the one or more DU-to-CU messages (e.g., UL RRC Message Transfer message(s)) including the subsequent UL data to the CU-CP 172A. Each DU-to-CU message can include a particular UL data packet of the subsequent UL data. In cases where the CU-CP 172A receives DL data from the CN 110 or edge server, the CU-CP 172A can transmit 418 one or more CU-to-DU messages (e.g., DL RRC Message Transfer message(s)) including the DL data (e.g., one or more DL data packets) to the DU 174. In turn, the DU 174 transmits 418 one or more DL MAC PDUs including the DL data to the UE 102 operating in the inactive state. In some implementations, the DL data can include or be NAS PDU(s) and/or LPP PDU(s).

In cases where the subsequent UL data is associated with one or more DRBs, the DU 174 transmits 418 the subsequent UL data to the CU-UP 172B, similar to the event 416. In some implementations, the DU 174 can include DU transport layer information of the DU 174 in the UE Context Setup Response message. The CU-CP 172A can then include the transport layer information of the DU 174 in the Bearer Context Modification Request message. The transport layer information of the DU 174 can include an IP address and/or a downlink TEID. In cases where the CU-UP 172B receives DL data from the CN 110 or edge server, the CU-UP 172B can transmit 418 the DL data (e.g., one or more DL data packets) to the DU 174 using the transport layer information of the DU 174. The DU 174 then transmits 418 one or more DL MAC PDUs including the DL data to the UE 102 operating in the inactive state.

In some implementations, the UE 102 can include a buffer status report or a power headroom report in the initial and/or subsequent UL MAC PDU(s), e.g., in accordance with the BSR configuration and/or PHR configuration, respectively. In the buffer status report, the UE 102 can include or indicate its buffer status for one or more logical channels or logical channel groups. In the power headroom report, the UE 102 can include or indicate power headroom status or value.

In some example scenarios, the subsequent UL data and/or DL data described above include IP packet(s), Ethernet packet(s), or application packet(s). In other scenarios, the UL data can include or be PDU(s) (e.g., RRC PDU(s), PDCP PDU(s) or RLC PDU(s)) that includes RRC message(s), NAS message(s), IP packet(s), Ethernet packet(s), or application packet(s).

The events 404, 406, 408, 410, 412, 414, 415 and 416 are collectively referred to in FIG. 4 as a small data transmission procedure 492.

In some implementations, the UL RRC message is an (existing) RRC resume request message (e.g., an RRCResumeRequest message, an RRCResumeRequest message, an RRCConnectionResumeRequest message, or an RRCConnectionResumeRequest message). In other implementations, the UL RRC message can be a new RRC resume request message, similar to the existing RRC resume request message. For example, the new RRC resume request message may be defined in future 3GPP standards documentation. The new RRC resume request message may have the format of an existing RRC resume request message. In the case of the downlink SDT, the UL RRC message can include an SDT indication, which can be a field or information element (IE) (e.g., resumeCause or ResumeCause). In some implementations, the UL RRC message is a common control channel (CCCH) message.

After the UE 102 transmits 404 the UL MAC PDU or communicates 418 the subsequent UL data and/or DL data with the DU 174, the CU-CP 172A can determine to stop the SDT for the UE 102 based on data inactivity of the UE 102 (i.e., based on the UE 102 in the inactive state having no data activity with the base station 104). After the UE 102 transmits 404 the UL MAC PDU or communicates 418 the subsequent UL data and/or DL data with the DU 174, the UE 102 in the inactive state determines or detects data inactivity and transmits 420 to the DU 174, UE assistance information (e.g., a UEAssistanceInformation message) indicating that the UE 102 decides (e.g., needs) to stop the SDT. In turn, the DU 174 transmits 421 a UL RRC Message Transfer message including the UE assistance information to the CU-CP 172A. Thus, the CU-CP 172A can determine that the UE 102 is in data inactivity based on the UE assistance information. In other implementations, the DU 174 can perform data inactivity monitoring for the UE 102. The CU-CP 172A can transmit a CU-to-DU message (e.g., the UE Context Setup Request message of the event 408 or a UE Context Modification Request message) to the DU 174 to request or command the DU 174 to perform the data inactivity monitoring. In cases where the DU 174 detects or determines that the UE 102 is in data inactivity during the monitoring, the DU 174 can transmit 422 an inactivity notification (e.g., UE Inactivity Notification message) to the CU-CP 172A. Thus, the CU-CP 172A can determine that the UE 102 is in data inactivity based on the inactivity notification received from the DU 174. In yet other implementations, the CU-UP 172B can perform data inactivity monitoring for the UE 102. The CU-CP 172A can transmit a CP-to-UP message to the CU-UP 172B to request or command the CU-UP 172B to perform the data inactivity monitoring. In some implementations, the CP-to-UP message can be a Bearer Context Setup Request message or a Bearer Context Modification Request message if sent before the UE 102 initiates the SDT. In other implementations, the CP-to-UP message can be a Bearer Context Modification Request message if sent during the SDT (e.g., the event 412). In cases where the CU-UP 172B detects or determines that the UE 102 is in data inactivity during the monitoring, the CU-UP 172B can transmit 423 an inactivity notification (e.g., Bearer Context Inactivity Notification message) to the CU-CP 172A. Thus, the CU-CP 172A can determine that the UE 102 is in data inactivity based on the inactivity notification received from the CU-UP 172B. In some implementations, the CU-CP 172A can determine that the UE 102 is in data inactivity based on the UE assistance information, the inactivity notification of the event 422, and/or the inactivity notification of the event 423.

After a certain period of data inactivity, the CU-CP 172A can determine that neither the CU 172 nor the UE 102 has transmitted any data in the downlink direction or the uplink direction, respectively, during the certain period. In response to the determination, the CU-CP 172A can determine to stop the SDT. Alternatively, the CU-CP 172A can determine to immediately stop the SDT for the UE 102 in response to determining that the UE 102 is in data inactivity.

In response to or after determining that the UE 102 is in data inactivity (for the certain period) or determining to transition the UE 102 to the inactive state with SDT configured, the CU-CP 172A sends 424 to the CP-CU 172B a Bearer Context Modification Request message to suspend data transmission for the UE 102. In response, the CU-UP 172B suspends data transmission for the UE 102 and sends 426 a Bearer Context Modification Response message to the CU-CP 172A. In response to or after determining that the UE 102 is in data inactivity (for the certain period) or determining to transition the UE 102 to the inactive state with SDT configured, the CU-CP 172A sends 428 a second CU-to-DU message (e.g., a UE Context Modification Request message) to instruct the DU 174 to provide an SDT DU configuration (e.g., a second SDT DU configuration) for the UE 102. In some implementations, the CU-CP 172A can include a SDT request indication (e.g., a field or IE) to request an SDT DU configuration in the second CU-to-DU message. In response to the SDT request indication or the second CU-to-DU message, the DU 174 transmits 430 a second DU-to-CU message (e.g., UE Context Modification Response message) including the second SDT DU configuration to the CU-CP 172A. Alternatively, the DU 174 does not include the second SDT DU configuration in the second DU-to-CU message. Instead, the DU 174 sends to the CU-CP 172A another DU-to-CU message (e.g., UE Context Modification Required message) including the second SDT DU configuration, after receiving the second CU-to-DU message or transmitting the second DU-to-CU message. In some alternative implementations, the CU-CP 172A can transmit the second CU-to-DU message and receive the second DU-to-CU message (or the other DU-to-CU message) before determining that the UE 102 is in data inactivity.

In response to determining to transition the UE 102 to the inactive state with SDT configured, the CU-CP 172A can generate an RRC release message (e.g., RRCRelease message or RRCConnectionRelease message) to transition the UE 102 to the inactive state. The CU-CP 172A can include the second SDT DU configuration (if obtained from the DU 174) and/or a second SDT CU configuration in the RRC release message.

Alternatively, the CU-CP 172A may not include a SDT configuration in the RRC release message. In this alternative, the CU-CP 172A can indicate the UE 102 to release or retain the first SDT CU configuration and/or the first SDT DU configuration in the RRC release message. For example, the CU-CP 172A can include a release indication indicating releasing the first SDT CU configuration or the first SDT DU configuration in the RRC release message. If the RRC release message does not include the release indication, the UE 102 retains the first SDT CU configuration and/or the first SDT DU configuration.

The CU-CP 172A then sends 432 to the DU 174 a third CU-to-DU message including the RRC release message. The DU 174 then transmits 434 the RRC release message to the UE 102. In some implementations, the DU 174 generates a MAC PDU including the RRC release message and transmits 434 the MAC PDU to the UE 102. The RRC release message instructs the UE 102 to be in the inactive state (e.g., to transition to the inactive state or to maintain the inactive state). The UE 102 stops the SDT and remains 436 in the inactive state upon receiving 434 the RRC release message.

The events 420 (optional), 421 (optional), 422 (optional), 423, 424, 426, 428, 430, 432, and 434 are collectively referred to in FIG. 4 as an SDT complete procedure 494.

During an SDT session (i.e., events 492 and 494), the UE 102 monitors a PDCCH using a C-RNTI to receive a DCI. In some implementations, the UE 102 receives the C-RNTI in the random access procedure described for the event 404. In other implementations, the UE 102 can receive and retain the C-RNTI as described for FIG. 3. In response to or after receiving 434 the RRC release message, the UE 102 stops using the C-RNTI to monitor a PDCCH. The UE 102 may retain the C-RNTI in response to or after receiving 434 the RRC release message or transitioning 436 to the inactive state from the connected state. In cases where the RRC release message 434 configures CG-SDT, the UE 102 in some implementations can retain the C-RNTI. In cases where the RRC release message 434 does not configure or releases CG-SDT, the UE 102 in some implementations can release the C-RNTI.

In some implementations, the second SDT CU configuration can be the same as the first SDT CU configuration. In other implementations, the second SDT CU configuration can be different from the first SDT CU configuration. The UE 102 can update (e.g., replace or modify) the first SDT CU configuration with the second SDT CU configuration. In some implementations, the CU-CP 172A can include an indication in the RRC release message to indicate that the UE 102 is to update the first SDT CU configuration with the second SDT CU configuration. In such implementations, the UE 102 can update the first SDT CU configuration with the second SDT CU configuration in response to the indication. In other implementations, the CU-CP 172A can include a modification indication in the RRC release message to indicate that the UE 102 is to modify the first SDT CU configuration with the second SDT CU configuration. In such implementations, the UE 102 can modify the first SDT CU configuration with the second SDT CU configuration in response to the modification indication. In yet other implementations, the CU-CP 172A can include a setup indication in the RRC release message to indicate that the UE 102 is to replace the first SDT CU configuration with the second SDT CU configuration. In such implementations, the UE 102 can replace the first SDT CU configuration with the second SDT CU configuration in response to the setup indication.

In some implementations, the second SDT DU configuration can be the same as the first SDT DU configuration. In other implementations, the second SDT DU configuration can be different from the first SDT DU configuration. The UE 102 can update (e.g., replace or modify) the first SDT DU configuration with the second SDT DU configuration. In some implementations, the DU 174 can include an indication in the second SDT DU configuration to indicate the UE 102 to update the first SDT DU configuration with the second SDT DU configuration. In such implementations, the UE 102 can update the first SDT DU configuration with the second SDT DU configuration in response to the indication. In other implementations, the DU 174 can include a modification indication in the second SDT DU configuration to indicate the UE 102 to modify the first SDT DU configuration with the second SDT DU configuration. In such implementations, the UE 102 can modify the first SDT DU configuration with the second SDT DU configuration in response to the modification indication. In yet other implementations, the DU 174 can include a setup indication in the second SDT DU configuration to indicate the UE 102 to replace the first SDT DU configuration with the second SDT DU configuration. In such implementations, the UE 102 can replace the first SDT DU configuration with the second SDT DU configuration in response to the setup indication.

In cases where the CU-CP 172A and/or the DU 174 support delta configuration, the CU-CP 172A may not send 428 the CU-to-DU message to obtain the second SDT DU configuration from the DU 174. Unless a condition for releasing the first SDT configuration is satisfied, the DU 174 retains the first SDT DU configuration. Alternatively, the CU-CP 172A can include the first SDT DU configuration in the second CU-to-DU message to cause the DU 174 to retain the first SDT DU configuration. In these cases, the CU-CP 172A may not include an SDT DU configuration and/or a SDT CU configuration in the RRC release message to cause the UE 102 to continue using the first SDT CU configuration and/or the first SDT DU configuration. In some implementations, the CU-CP 172A may not include a release indication in the RRC release message in order to configure the UE 102 to continue using the first SDT DU configuration and/or the first SDT CU configuration. The release indication indicates that the UE 102 is to release the previously received SDT DU configuration and/or the SDT CU configuration. In cases where the CU-CP 172A includes the release indication in the RRC release message, the UE 102 releases the first SDT CU configuration and/or the first SDT DU configuration in response to the release indication.

In cases where the CU-CP 172A and/or DU 174 do not support delta configurations, the CU-CP 172A may include the SDT DU configuration and/or the SDT CU configuration in the RRC release message as described above.

In response to the third CU-to-DU message, the DU 174 can retain the second SDT DU configuration and may or may not release the first non-SDT DU configuration and/or second non-SDT DU configuration. The DU 174 can send a third DU-to-CU message (e.g., a UE Context Release Complete message or a UE Context Modification Response message) to the CU-CP 172A in response to the third CU-to-DU message. In some implementations, if the RRC release message instructs the UE 102 to transition to the inactive state (i.e., RRC_IDLE), the UE 102 releases a non-SDT configuration (e.g., the first non-SDT DU configuration, first non-SDT CU configuration, second non-SDT DU configuration and/or second non-SDT CU configuration described for FIG. 3) and at least one SDT configuration (e.g., the SDT DU configuration and SDT CU configuration described for FIG. 3).

The events 420 (optional), 421 (optional), 422 (optional), 423, 424, 426, 428, 430, 432, and 434 are collectively referred to in FIG. 4 as a SDT complete procedure 494, similar to the procedure 394. Examples and implementations for events 320, 321, 322, 323, 324, 326, 328, 330, 332, 334 can apply to events 420, 421, 422, 423, 424, 426, 428, 430, 432, 434, respectively. After stopping the SDT, if the UE 102 is still configured with a SDT configuration, the UE 102 can perform 493 another SDT procedure with the base station 104, similar to the procedure 492. After completing the procedure 493, the base station 104 can perform an SDT complete procedure 495 with the UE 102, similar to the procedure 494.

In some implementations, the CU-CP 172A may not request the DU 174 to provide an SDT DU configuration for transitioning the UE 102 to the inactive state with SDT configured. In such cases, the events 428 and 430 can omitted. In such cases, the CU-CP 172A does not include an SDT DU configuration in the RRC release message. Alternatively, the CU-CP 172A may generate the SDT DU configuration by itself and include the SDT DU configuration in the RRC release message.

In some implementations, the DU 174 does not include an SDT DU configuration in the second DU-to-CU message, e.g., if or because the UE 102 does not support CG-SDT, the DU 174 does not support CG-SDT or the DU 174 does not have available radio resources for CG-SDT. In such cases, the RRC release message does not include a SDT DU configuration. Otherwise, the DU 174 can include an SDT DU configuration as described above. In some implementations, the DU 174 does not include a CG-SDT configuration in the SDT DU configuration in the second DU-to-CU message, e.g., if or because the UE 102 does not support CG-SDT, the DU 174 does not support CG-SDT or the DU 174 does not have available radio resources for CG-SDT. In such cases, the SDT DU configuration does not include a CG-SDT configuration. Otherwise, the DU 174 can include the at least one CG-SDT configuration in the SDT DU configuration as described above.

In some implementations, the CU-CP 172A can request the DU 174 to provide an SDT DU configuration as described above, in cases where the UE 102 supports CG-SDT and/or the DU 174 supports CG-SDT. In cases where the UE 102 does not support CG-SDT or the DU 174 does not support CG-SDT, the CU-CP 172A does not request the DU 174 to provide an SDT DU configuration. The CU-CP 172A can receive a UE capability (e.g., UE-NR-Capability IE) of the UE 102 from the UE 102, the CN 110 (e.g., MME 114 or AMF 164) or the base station 106, either before the UE 102 initiated the SDT, while the UE operates 402 in the inactive state, while the UE performs the SDT (e.g., in the UE Context Setup Request message of the event 408 or the CU-to-DU message of the event 428) or while the UE operates in the connected state as described for FIG. 3. The UE capability indicates whether the UE 102 supports CG-SDT. Thus, the CU-CP 172A can determine whether the UE supports CG-SDT in accordance with the UE capability. In some implementations, the CU-CP 172A can receive from the DU 174 a DU-to-CU message indicating whether the DU 174 supports CG-SDT. The DU-to-CU message can be the second DU-to-CU message, the message of the event 308 or 316, or a non-UE associated message (e.g., a non-UE associated F1AP message defined in 3GPP specification 38.473).

In some implementations, the DU 174 may determine whether to provide an SDT DU configuration for the UE 102 to the CU-CP 172A, depending on whether the UE 102 supports CG-SDT or not. In addition to whether the UE 102 supports CG-SDT or not, the DU 174 may additionally determine whether to provide an SDT DU configuration for the UE 102 to the CU-CP 172A, depending on whether the DU 174 supports CG-SDT or not. In cases where the UE 102 supports CG-SDT and/or the DU 174 supports or enables CG-SDT, the DU 174 provides an SDT DU configuration for the UE 102 to the CU-CP 172A as described above. In cases where the UE 102 does not support CG-SDT or the DU 174 does not support CG-SDT, the DU 174 does not provide an SDT DU configuration for the UE 102 (e.g., the DU 174 does not include the SDT DU configuration in the second DU-to-CU message). The DU 174 can receive the UE capability from the CU-CP 172A, e.g., while the UE 102 operates in the connected state or in the inactive state. Thus, the DU 174 can determine whether the UE 102 supports CG-SDT in accordance with the UE capability. In some implementations, the DU 174 can send a DU-to-CU message to the CU-CP 172A to indicate whether the DU 174 supports or does not support CG-SDT, as described above.

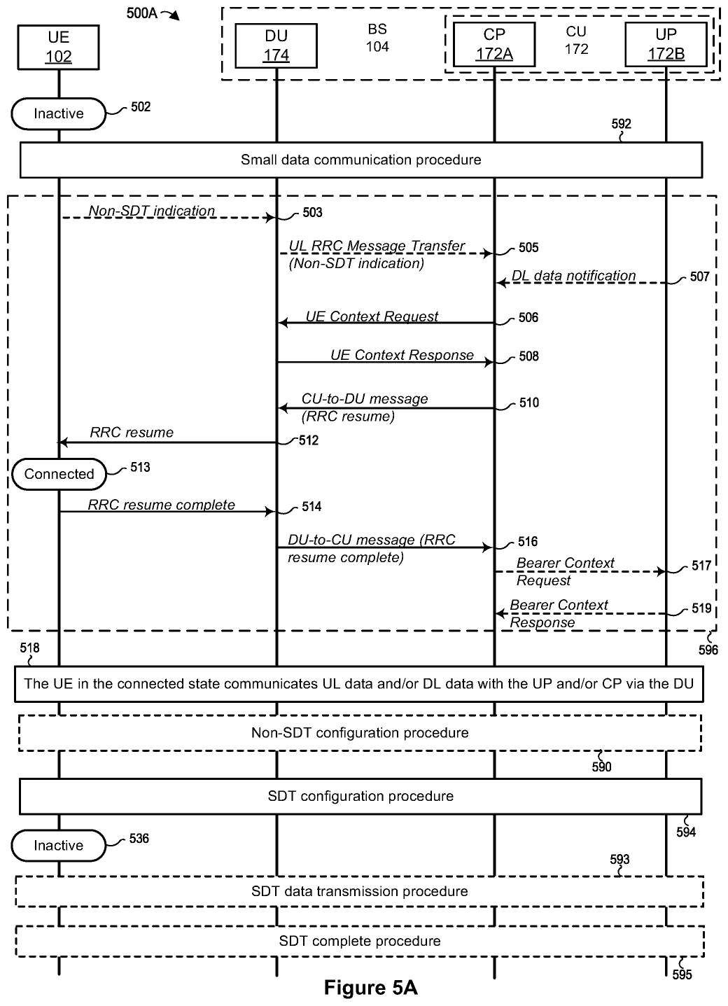

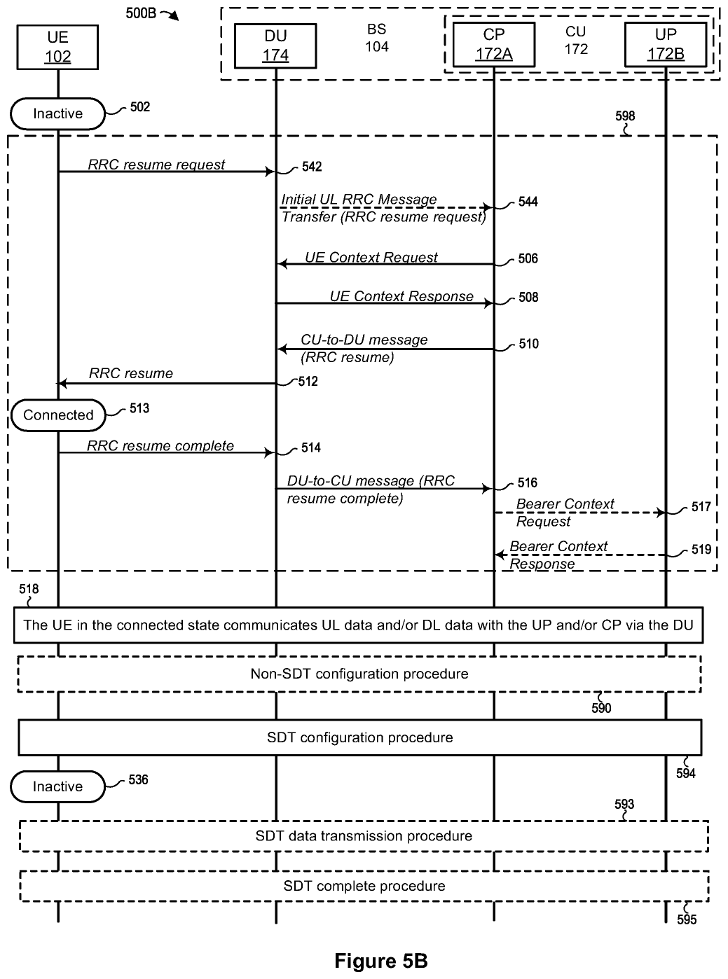

Referring now to FIG. 5A, a scenario 500A depicts small data transmission and transitioning from SDT to non-SDT. In the scenario 500A, the base station 104 includes a CU 172 and a DU 174, the CU 172 includes a CU-CP 172A and a CU-UP 172B, and the UE 102 initially operates 502 in an inactive state with SDT configured, similar to the event 402. The UE 102 then performs an SDT procedure 592 with the base station 104, similar to the event 492.

During the small data transmission procedure 592, the CU-CP 172A can determine whether to transition the UE 102 to a connected state, e.g., based on UL or DL data activity of the UE 102. In some implementations, the UE 102 can transmit 503 to the DU 174 a non-SDT indication message to indicate that UL data is available or request to transition to the connected state. In some implementations, the UE 102 can transmit 503 to the DU 174 the non-SDT indication message on radio resources configured in a CG configuration for SDT (or CG-SDT configuration). In other implementations, the UE 102 can receive an uplink grant on a PDCCH from the DU 174 using a C-RNTI and transmit 503 to the DU 174 the non-SDT indication message on radio resources configured in the uplink grant. The DU 174 then transmits 505 a UL RRC Message Transfer message including the non-SDT indication message to the CU-CP 172A. The CU-CP 172A can determine to transition the UE 102 to the connected state in response to or based on the non-SDT indication message. In other implementations, the CU-UP 172B receives DL data from the CN 110, and in response transmits 507 a DL data notification (e.g., DL Data Notification message) to the CU-CP 172A to indicate that DL data is available for transmission. The CU-CP 172A can determine to transition the UE 102 to the connected state in response to or based on the DL data notification. In yet other implementations, the CU-CP 172A can determine to transition the UE 102 to the connected state based on measurement results received from the UE 102. In yet other implementations, the CU-CP 172A receives DL data (e.g., NAS message(s)) from the CN 110 and in response can determine to transition the UE 102 to the connected state.

In some implementations, the non-SDT indication message can be a RRC message (e.g., a UEAssistanceInformation message or a new RRC message).

In some implementations, the UL data and/or DL data is/are associated with radio bearer(s) (e.g., SRB(s) and/or DRB(s)). For example, the UL data can include RRC message(s) or NAS message(s) associated to SRB(s). In another example, the UL data includes IP packet(s) associated with DRB(s). In some implementations, the UE 102 can include ID(s) of the radio bearer(s) in the non-SDT indication message. Thus, the CU-CP 172A can determine whether to transition the UE 102 to the connected state based on the ID(s). For example, if the radio bearer(s) identified by the ID(s) do not qualify for SDT, the CU-CP 172A can determine to transition the UE 102 to the connected state. Otherwise, the CU-CP 172A can determine not to transition the UE 102 to the connected state. In some implementations, the UE 102 can include data volume information of the UL data in the non-SDT indication message. Thus, the CU-CP 172A can determine whether to transition the UE 102 to the connected state based on the data volume information. In one implementation, the data volume information includes a total data volume of the UL data, which can be quantized or rounded to a value that can be indicated in the data volume information. In another implementation, the data volume information includes a data volume for each of the radio bearer(s), which can be quantized or rounded to a value that can be indicated in the data volume information. For example, if the total data volume is above a predetermined threshold, the CU-CP 172A can determine to transition the UE 102 to the connected state. Otherwise, the CU-CP 172A can determine not to transition the UE 102 to the connected state. In another example, if the data volume for a particular radio bearer is above a predetermined threshold, the CU-CP 172A can determine to transition the UE 102 to the connected state. Otherwise, the CU-CP 172A can determine not to transition the UE 102 to the connected state. In yet another example, if the total data volume is above a predetermined threshold and the data volume for a particular radio bearer is above another predetermined threshold, the CU-CP 172A can determine to transition the UE 102 to the connected state. Otherwise, the CU-CP 172A can determine not to transition the UE 102 to the connected state.

In response to or after determining to transition the UE 102 to the connected state, the CU-CP 172A transmits 506 a UE Context Request message (e.g., a UE Context Setup Request message or a UE Context Modification Request message) to the DU 174. In response, the DU 174 transmit 508 a UE Context Response message (e.g., a UE Context Setup Response message or a UE Context Modification Response message) to the CU-CP 172A. In some implementations, the DU 174 can include a non-SDT DU configuration (i.e., a first non-SDT DU configuration) in the UE Context Response message. After receiving the UE Context Response message, the CU-CP 172A transmits 510 a CU-to-DU message including a RRC resume message (e.g., an RRCResume message or an RRCConnectionResume message) to the DU 174. The DU 174 then transmits 512 the RRC resume message to the UE 102. In some implementations, the DU 174 can transmit 512 one or more PDUs including the RRC resume message to the UE 102. The PDU(s) can be MAC PDU(s) or RLC PDU(s). In some implementations, the CU-to-DU message can be a DL RRC Message Transfer message or a UE Context Modification Request message. In the case of the UE Context Modification Request message, the DU 174 can transmit a UE Context Modification Response message to the CU-CP 172A in response. In response to the RRC resume message, the UE 102 transitions 513 to the connected state and transmits 514 a RRC resume complete message (e.g., an RRCResumeComplete message or an RRCConnectionResumeComplete message) to the DU 174. In cases where the UE Context Response message includes the non-SDT DU configuration, the CU-CP 172A includes the non-SDT DU configuration in the RRC resume message. The DU 174 transmits 516 a DU-to-CU message including the RRC resume complete message to the CU-CP 172A. After determining to transition the UE 102 to the connected state, the CU-CP 172A can transmit a 517 Bearer Context Request message (e.g., a Bearer Context Setup Request message or a Bearer Context Modification Request message) to the CU-UP 172B to indicate the CU-UP 172B to resume all suspended radio bearer(s) for the UE 102. In response, the CU-UP 172B resumes all suspended radio bearer(s) for the UE 102 and transmits 519 a Bearer Context Response message (e.g., a Bearer Context Setup Response message or a Bearer Context Modification Response message) to the CU CP-172A. In some implementations, the CU-CP 172A can transmit 517 the Bearer Context Request message after transmitting 506 the UE Context Request message, receiving 508 the UE Context Response message, transmitting 510 the CU-to-DU message, or receiving 516 the DU-to-CU message.

In some implementations, the CU-CP 172A can include an indication indicating the DU 174 to generate a non-SDT configuration in the UE Context Request message, and the DU 174 includes the first non-SDT DU configuration in the UE Context Response message in response to the indication. In yet other implementations, the CU-CP 172A stores a non-SDT DU configuration (i.e., a second non-SDT DU configuration) that a DU (e.g., the DU 174 or another DU or base station) uses to communicate with the UE 102. The UE 102 can also store the second non-SDT DU configuration. In such cases, the CU-CP 172A includes the second non-SDT DU configuration in the UE Context Request message, and the DU 174 can includes the first non-SDT DU configuration in the UE Context Response message in response to receiving the second non-SDT DU configuration. In some implementations, the first non-SDT DU configuration augments or replaces the second non-SDT DU configuration. Examples and implementations for the first and second non-SDT DU configurations may be the same as those described above for the non-SDT DU configurations. In some implementations, the DU 174 can transmit an additional DU-to-CU message (e.g., a UE Context Modification Required message) including the first non-SDT DU configuration to the CU-CP 172A instead of including the first non-SDT DU configuration in the UE Context Response message.

After transitioning to the connected state, the UE 102 communicates 518 UL data and/or DL data with the CU-CP 172A and/or CU-UP 172B via the DU 174. The UL data can include the UL data triggering the UE 102 to transmit the non-SDT indication message. The UL data can also include new UL data available for transmission. The DL data can include the DL data received from the CN 110 as described above. The DL data can also include new DL data received from the CN 110. In cases where the RRC resume message includes the first non-SDT DU configuration, the UE 102 communicates 518 with the DU 174 using the first non-SDT DU configuration. In cases where the second non-SDT DU configuration is not completely replaced by the first non-SDT DU configuration (i.e., the UE 102 does not release the second non-SDT DU configuration in response to the RRC resume message), the UE 102 can communicate 518 with the DU 174 using the configuration parameters in the second non-SDT DU configuration, which are not augmented by the first non-SDT DU configuration.

In some implementations, the DU 174 may not provide the first non-SDT DU configuration to the CU-CP 172A in the UE Context Response message and the additional DU-to-CU message. In such cases, the RRC resume message does not include the first non-SDT configuration, and the UE 102 and the DU 174 communicate 518 with one another using the second non-SDT DU configuration.

In some implementations, the UE 102 releases the SDT configuration(s) (e.g., the SDT CU configuration, the SDT DU configuration and/or the CG-SDT configuration(s) in response to the RRC resume message or transitioning to the connected state. In some implementations, the base station 104 (e.g., the CU-CP 172A and/or DU 174) releases the SDT configuration(s) in response to or after transitioning the UE 102 to the connected state, receiving 510 the CU-to-DU message, or transmitting 510, 512 the RRC resume message. In other implementations, the base station 104 releases the SDT configuration(s) in response to or after receiving an acknowledgement (e.g., an RLC acknowledgement or a HARQ acknowledgement) for the PDU(s) including the RRC resume message. In still other implementations, the base station 104 (e.g., the CU-CP 172A and/or DU 174) releases the SDT configuration(s) in response to or after communicating 506 the UE Context Request message or communicating 508 the UE Context Response message.

In other implementations, the UE 102 retains the SDT configuration(s) (e.g., the SDT CU configuration, the SDT DU configuration and/or the CG-SDT configuration(s)) in response to or after receiving the RRC resume message or transitioning to the connected state. In some implementations, the UE 102 refrains from using the SDT configuration(s) to communicate (e.g., transmit 514 the RRC resume complete message and/or communicate 518 data) with the base station 104, while operating in the connected state. In other implementations, the UE 102 can use the SDT configuration(s) to communicate (e.g., 514 the RRC resume complete message and/or 518 data) with the base station 104, while operating in the connected state. In some implementations, the base station 104 retains the SDT configuration(s) in response to or after transitioning the UE 102 to the connected state or transmitting the RRC resume message. In some implementations, the base station 104 refrains from using the SDT configuration(s) to communicate (e.g., receive 514 the RRC resume complete message and/or communicate 518 data) with the UE 102 operating in the connected state. In other implementations, the base station 104 can use the SDT configuration(s) to communicate (e.g., receive 514 the RRC resume complete message and/or communicate 518 data) with the UE 102 operating in the connected state.

Later in time, the base station 104 can perform a non-SDT configuration procedure 590 and an SDT configuration procedure 594 with the UE 102, similar to the procedure 390 and the procedure 394, respectively. The UE 102 transitions 536 to the inactive state in response to receiving an RRC release message in the procedure 594. Then, the base station 104 can perform an SDT procedure 593 and an SDT complete procedure 595 with the UE 102, similar to the procedure 492 and the procedure 494, respectively.

Referring next to FIG. 5B, a scenario 500B is generally similar to the scenario 500A, except that the UE 102 initiates a RRC connection resume procedure instead of the small data communication procedure 592. The differences between the scenarios 500B and 500A are discussed below.

In response to initiating the RRC connection resume procedure, the UE 102 transmits 542 a RRC resume request message to the DU 174, which in turn transmits 544 an Initial UL RRC Message Transfer message including the RRC resume request message (e.g., an RRCResumeRequest message or an RRCConnectionResumeRequest message) to the CU-CP 172A. In response to receiving the RRC resume request message, the CU-CP 172A determines to transition the UE 102 to the connected state. In response to or after determining to transition the UE 102 to the connected state, the CU-CP 172A transitions the UE 102 to the connected state as described for the scenario 500A.

In some implementations, the UE 102 can generate a UL MAC PDU including the RRC resume request message and transmits 542 UL MAC PDU to the DU 174. In some implementations, the UE 102 can transmit 542 to the DU 174 the UL MAC PDU on radio resources configured in a CG configuration for SDT. In other implementations, the UE 102 can perform a random access procedure to transmit the UL MAC PDU, similar to the event 404.

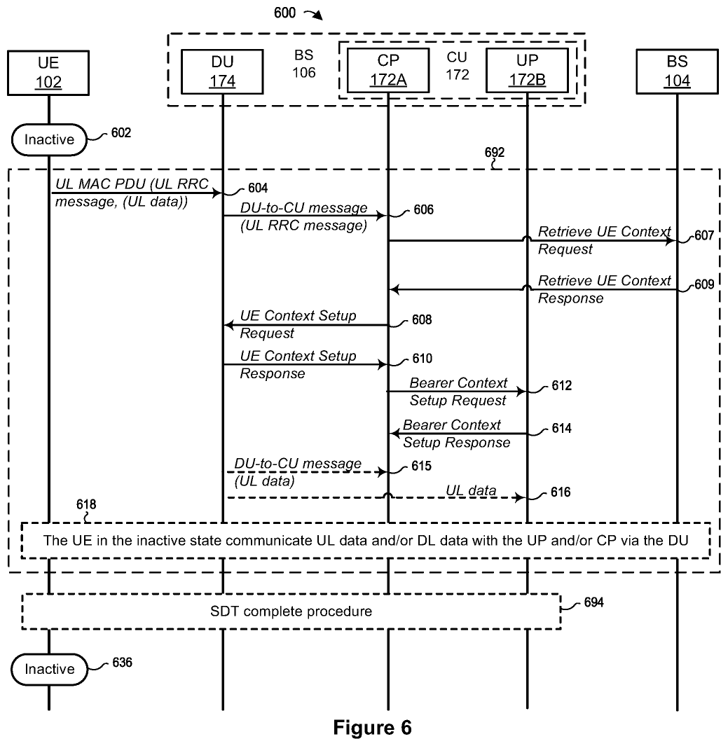

Referring next to FIG. 6, a scenario 600 depicts SDT operation, similar to the scenario 400 except for events 607 and 609. Events 602, 604, 606, 608, 610, 612, 614, 615, 616, 618, 694, 636 are similar to events 402, 404, 406, 408, 410, 412, 414, 415, 416, 418, 494, 436. Examples and implementations for FIG. 4 can apply to FIG. 6. The differences between FIG. 4 and FIG. 6 are described below.

In the scenario 600, the UE 102 initially operates 602 in an inactive state with an SDT configuration as configured by the base station 104, as described above for FIG. 3 or FIG. 4. In some implementations, the SDT configuration includes one or more CG-SDT configurations. In such cases, the UE 102 can discard the CG-SDT configuration(s) because the base station 106 does not configure the CG-SDT configuration(s) for the UE 102, i.e., the CG-SDT configuration(s) is not valid.

In response to or after receiving 606 the UL RRC message, the CU-CP 172A transmits 607 a Retrieve UE Context Request message to the base station 104. In response, the base station 104 transmits 609 a Retrieve UE Context Response message to the CU-CP 172A. After receiving the Retrieve UE Context Response message, the CU-CP 172A transmits 608 a UE Context Setup Request message to the DU 174, and receives 610 a UE Context Setup Response message from the DU 174. The CU-CP 172A transmits 612 a Bearer Context Setup Request message to the CU-UP 172B to request the CU-UP 172B to set up bearer context(s) for SDT DRB(s) that is/are configured in the SDT configuration. In response, the CU-UP 172B sets up bearer context(s) for the SDT DRB(s) and transmits 614 a Bearer Context Setup Response message to the CU-CP 172A to confirm that the bearer context(s) for the SDT DRB(s) has/have been set up.

In some implementations, the base station 104 can include the SDT configuration in the Retrieve UE Context Response message. In cases where the SDT configuration includes one or more CG-SDT configurations, the base station 104 can exclude the CG-SDT configuration(s) from the SDT configuration. Alternatively, the CU-CP 172A still includes the CG-SDT configuration(s) from the SDT configuration. In some implementations, when the CU-CP 172A receives the CG-SDT configuration(s), the CU-CP 172A discards the CG-SDT configuration(s). In some implementations, the CU-CP 172A can discard the SDT configuration, in cases where the CU-CP 172A does not support delta configuration. In cases where the CU-CP 172A supports delta configuration, the CU-CP 172A can take the SDT configuration (e.g., a first SDT configuration) into account when the CU-CP 172A determines to transition the UE to the inactive state at the SDT complete procedure 694, similar to the procedure 494.

In other implementations, the CU-CP 172A refrains from including the SDT configuration in the Retrieve UE Context Request message.

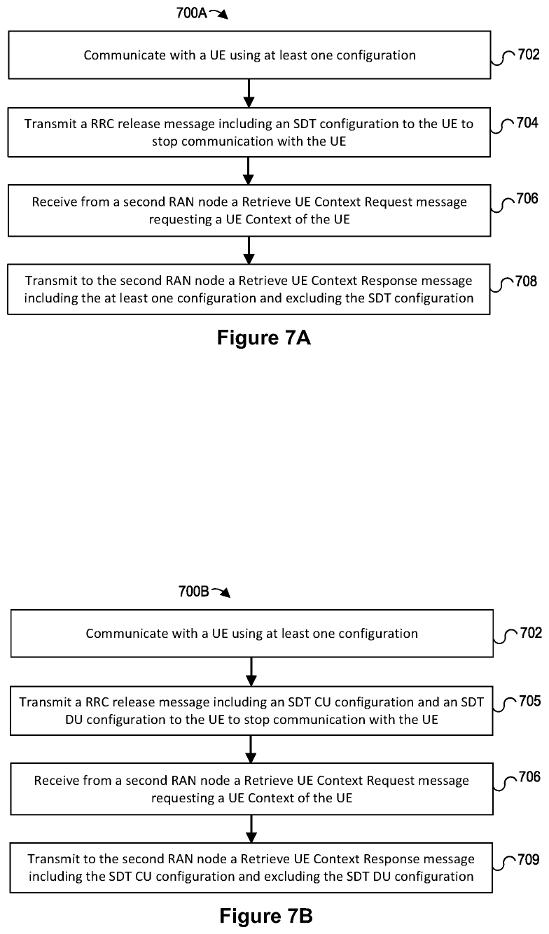

Next, several example methods, that can be implemented in one or more RAN nodes (e.g., base station(s), DU(s), or CU(s)) to support data communications in the inactive state, are discussed with reference to FIGS. 7A-11.

FIG. 7A illustrates a method 700A, which can be implemented/performed by a first RAN node (e.g., the base station 104, the CU 172 of the base station 104 or the CU-CP 172A of the base station 104) for managing SDT for a UE (e.g., the UE 102).

The method 700A begins at block 702, where the first RAN node communicates with a UE using at least one configuration (e.g., events 312, 314, 318, 390, 320, 334, 394, 514, 518, 596, 598). At block 704, the first RAN node transmits an RRC release message including an SDT configuration to the UE to stop communication with the UE (e.g., events 334, 434, 394, 494, 594, 595). At block 706, the first RAN node receives from a second RAN node (e.g., the base station 106, the CU 172 of the base station 106, or the CU-CP 172A of the base station 106) a Retrieve UE Context Request message requesting a UE Context of the UE (e.g., event 607). At block 708, the first RAN node transmits to the second RAN node a Retrieve UE Context Response message including the at least one configuration and excluding the SDT configuration (e.g., event 609).

In some implementations, the at least one configuration includes multiple configuration parameters. In some implementations, the first RAN node communicates with the UE operating in a connected state at block 702. In some implementations, the first RAN node transmits an RRC reconfiguration message including some or all of the multiple configuration parameters to the UE, while the UE operates in the connected state. In other implementations, the first RAN node transmits an RRC resume message including some or all of the multiple configuration parameters to the UE while the UE operates in an inactive state. In some implementations, the multiple configuration parameters can be configuration parameters included in a CellGroupConfig IE.

FIG. 7B is a flow diagram of an example method 700B, which is similar to the method 700A except that the method 700B includes blocks 705 and 709 instead of blocks 704 and 706. At block 705, the first RAN node transmits an RRC release message including an SDT CU configuration and an SDT DU configuration to the UE to stop communication with the UE (e.g., events 334, 434, 394, 494, 594, 595). At block 709, the first RAN node transmits to the second RAN node a Retrieve UE Context Response message including the SDT CU configuration and excluding the SDT DU configuration (e.g., events 334, 434, 394, 494, 594, 595).

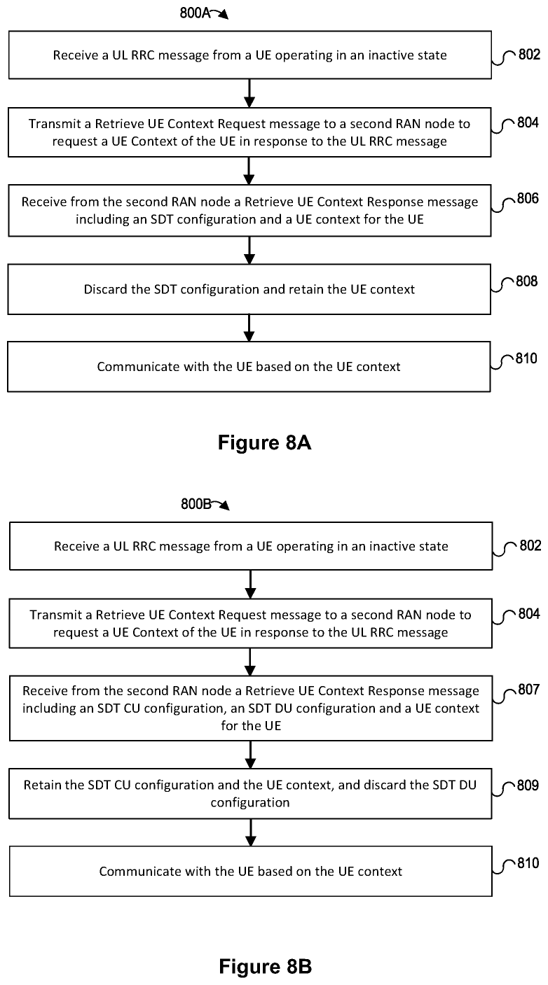

FIG. 8A illustrates a method 800A, which can be implemented/performed by a first RAN node (e.g., the base station 106, the CU 172 of the base station 106 or the CU-CP 172A of the base station 106) for managing SDT for a UE (e.g., the UE 102).

The method 800A begins at block 802, where the first RAN node receives a UL RRC message from a UE operating in an inactive state (e.g., events 404, 503, 542, 604). At block 804, the first RAN node transmits a Retrieve UE Context Request message to a second RAN node (e.g., the base station 104, the CU 172 of the base station 104, or the CU-CP 172A of the base station 104) to request a UE Context of the UE in response to the UL RRC message (e.g., event 607). At block 806, the first RAN node receives from the second RAN node a Retrieve UE Context Response message including an SDT configuration and a UE context for the UE (e.g., event 609). At block 808, the RAN node discards the SDT configuration and retains the UE context. At block 810, the RAN node communicates with the UE based on the UE context (e.g., events 512, 514, 518, 596, 598, 618, 694).

FIG. 8B is a flow diagram of an example method 800B, which is similar to the method 800A except that method 800B includes block 807 instead of block 806, and block 809 instead of block 808. At block 807, the first RAN node receives from the second RAN node a Retrieve UE Context Response message including an SDT CU configuration, an SDT DU configuration, and a UE context for the UE (e.g., event 609). At block 809, the first RAN node retains the SDT CU configuration and the UE context, and discards the SDT DU configuration.

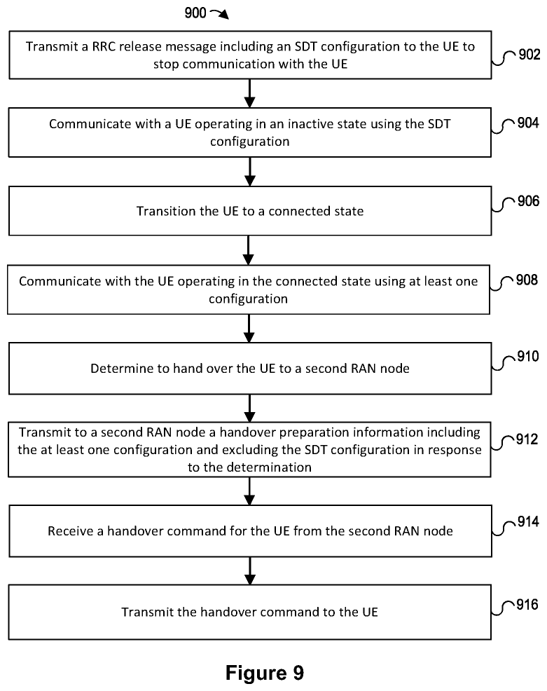

FIG. 9 illustrates a method 900, which can be implemented/performed by a first RAN node (e.g., the base station 104, the CU 172 or the CU-CP 172A) for managing SDT for a UE (e.g., the UE 102).

The method 900 begins at block 902, where the first RAN node transmits an RRC release message including an SDT configuration to the UE to stop communication with the UE (e.g., events 332, 334, 432, 434, 394, 494, 594, 595). At block 904, the first RAN node communicates with a UE operating in an inactive state using the SDT configuration (e.g., events 404, 406, 418, 492, 420, 421, 432, 434, 494, 592, 594, 593, 594). At block 906, the first RAN node transitions the UE to a connected state (e.g., events 510, 512). At block 908, the first RAN node communicates with the UE operating in the connected state using at least one configuration (e.g., events 514, 516, 518). At block 910, the first RAN node determines to hand over the UE to a second RAN node (e.g., the base station 106, the CU 172 of the base station 106, or the CU-CP 172A of the base station 106). At block 912, the RAN node transmits to a second RAN node a handover preparation information including the at least one configuration and excluding the SDT configuration in response to the determination. At block 914, the RAN node receives a handover command message for the UE from the second RAN node. At block 916, the RAN transmits the handover command to the UE.

In some implementations, the second RAN node can generate the handover command message, which can be or include an RRC reconfiguration message, for example. In some implementations, the first RAN node transmits a Handover Request message including the handover preparation information to the second RAN node. In response, the first RAN node receives a Handover Request Acknowledge message including the handover command message from the second RAN node.

In some implementations, the first RAN node transmits the handover preparation information to the second RAN node via a CN (e.g., CN 110) and receives the handover command message from the second RAN node via the CN. For example, the first RAN node transmits a Handover Required message including the handover preparation information to the CN (e.g., CN 110), which in turn transmits a Handover Request message including the handover preparation information to the second RAN node. In response, the second RAN node transmits a Handover Request Acknowledge message including the handover command message to the CN, which in turn transmits a Handover Command message (i.e., an interface message such as X2 or Xn interface message) including the handover command message to the first RAN node.

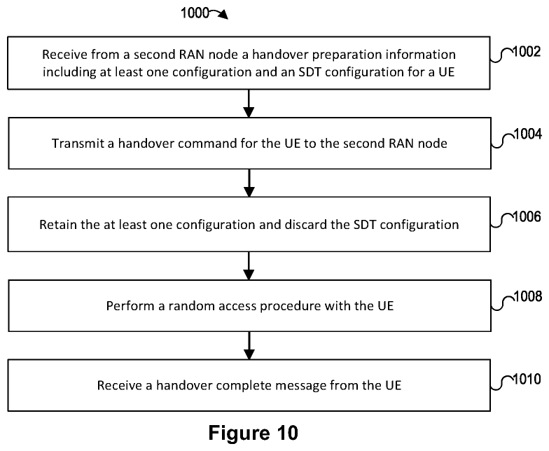

FIG. 10 illustrates a method 1000, which can be implemented/performed by a first RAN node (e.g., the base station 106, the CU 172 of the base station 106, or the CU-CP 172A of the base station 106) for managing SDT for a UE (e.g., the UE 102).

The method 1000 begins at block 1002, where the first RAN node receives from a second RAN node a handover preparation information including at least one configuration and an SDT configuration for a UE. At block 1004, the RAN node transmits a handover command for the UE to the second RAN node. At block 1006, the RAN node retains at least one configuration and discards the SDT configuration. At block 1008, the RAN node performs a random access procedure with the UE. At block 1010, the RAN node receives a handover complete message from the UE.

In some implementations, the first RAN node and second RAN node of FIG. 10 can be the second RAN node and first RAN node of FIG. 9, respectively. Examples and implementations for FIG. 9 can apply to FIG. 10.

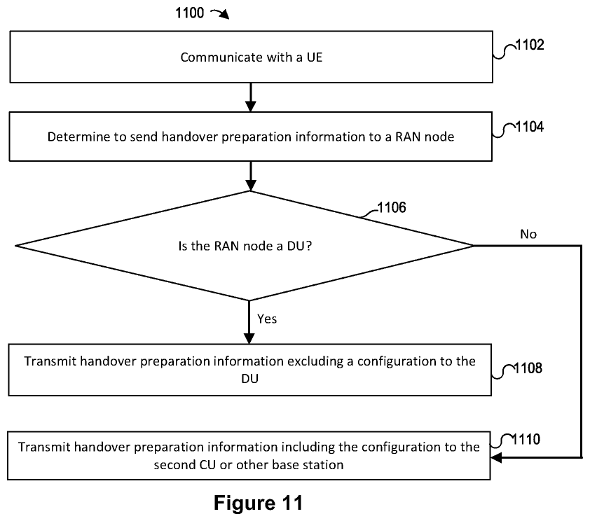

FIG. 11 illustrates a method 1100, which can be implemented by a first CU (e.g., the CU 172 or the CU-CP 172A) for managing SDT for a UE (e.g., the UE 102).

The method 1100 begins at block 1102, where the CU communicates with a UE. At block 1104, the first CU determines to send a handover preparation information to a RAN node. At block 1106, the first CU determines whether the RAN node is a DU. If the CU determines the RAN node is a DU, the flow proceeds to block 1108. At block 1108, the first CU transmits a handover preparation information excluding a configuration (e.g., an SDT configuration described above) to the DU. In some implementations, the first CU can transmit a CU-to-DU message including the handover preparation information to the DU. Otherwise, if the first CU determines the RAN node is not a DU (e.g., the RAN node is a second CU or a base station), the flow proceeds to block 1110. At block 1110, the first CU transmits handover preparation information including the configuration to the second CU. Examples and implementations of transmitting the handover preparation information for FIG. 9 can apply to FIG. 11.

The following list of examples reflects a variety of the implementations explicitly contemplated by the present disclosure:

Example 1. A method, performed by a first radio access network (RAN) node, of managing configuration information for small data transmission (SDT) operation, the method comprising: receiving a radio resource control (RRC) message from a user equipment (UE); receiving, from a second RAN node and during a handover procedure from the second RAN node to the first RAN node, an SDT configuration for use by the UE when the UE is operating in an RRC inactive state; and after the handover procedure, communicating with the UE operating in the RRC inactive state based on a UE context of the UE.

Example 2. The method of example 1, wherein receiving the SDT configuration includes receiving a UE context response message that includes the SDT configuration.

Example 3. The method of example 2, further comprising: after receiving the RRC message and before receiving the UE context response message, transmitting a UE context request message to the second RAN node.

Example 4. The method of example 2 or 3, wherein receiving the SDT configuration includes receiving a UE context response message that contains the SDT configuration and the UE context.

Example 5. The method of any one of examples 1-4, wherein the RRC message is an RRC resume message.

Example 6. The method of any one of examples 1-5, further comprising: after receiving the SDT configuration, discarding at least a portion of the SDT configuration.

Example 7. A method, performed by a first radio access network (RAN) node, of managing configuration information for small data transmission (SDT) operation, the method comprising: receiving, from a second RAN node and during a handover procedure from the second RAN node to the first RAN node, an SDT configuration for use by a user equipment (UE) when the UE is operating in a radio resource control (RRC) inactive state; discarding at least a portion of the SDT configuration; and after the handover procedure, communicating with the UE operating in the RRC inactive state.

Example 8. The method of example 7, further comprising: before receiving the SDT configuration from the second RAN node, transmitting to the second RAN node a message requesting a UE context, wherein receiving the SDT configuration includes receiving a message including the SDT configuration and the UE context, and wherein communicating with the UE operating in the RRC inactive state includes communicating with the UE based on the UE context.

Example 9. The method of example 8, wherein the discarding includes discarding the SDT configuration.

Example 10, The method of example 8, wherein the discarding includes discarding an SDT distributed unit (SDT DU) configuration and retaining an SDT central unit (SDT CU) configuration.

Example 11. The method of any one of examples 8-10, further comprising: before transmitting the message requesting the UE context, receiving an RRC message and uplink data from the UE operating in the RRC inactive state.

Example 12. The method of example 7, wherein receiving the SDT configuration includes receiving, from the second RAN node, handover preparation information including a non-SDT configuration and the SDT configuration, and wherein the method comprises: retaining the non-SDT configuration and discarding the SDT configuration.

Example 13. The method of example 12, further comprising: after receiving the handover preparation information, transmitting a handover command for the UE to the second RAN node.

Example 14. The method of example 12 or 13, further comprising, after transmitting the handover command: performing a random access procedure with the UE; and receiving a handover complete message from the UE.

Example 15. The method of any one of examples 12-14, wherein receiving the handover preparation information occurs via a core network (CN).

Example 16. The method of any one of examples 7-15, wherein: the first RAN node is a target base station in the handover procedure; and the second RAN node is a source base station in the handover procedure.

Example 17. The method of any one of examples 7-15, wherein: the first RAN node is a central unit (CU) of a distributed base station that is a target base station in the handover procedure; the second RAN node is a source base station in the handover procedure; and communicating with the UE occurs via a distributed unit (DU) of the distributed base station.

Example 18. A method, performed by a first radio access network (RAN) node, of managing configuration information for small data transmission (SDT) operation, the method comprising: communicating with a user equipment (UE) operating in a radio resource control (RRC) inactive state using an SDT configuration; transitioning the UE from the RRC inactive state to an RRC connected state; communicating with the UE operating in the RRC connected state using a non-SDT configuration; determining to hand over the UE to a second RAN node; and in response to the determining, transmitting handover preparation information to the second RAN node, the handover preparation information excluding the SDT configuration.

Example 19. The method of example 18, wherein the handover preparation information includes the non-SDT configuration.

Example 20. The method of example 18 or 19, further comprising: before communicating with the UE operating in the RRC inactive state, transmitting an RRC release message including the SDT configuration to the UE.

Example 21. The method of any one of examples 18-20, wherein transitioning the UE to the RRC connected state includes transmitting an RRC resume message to the UE.

Example 22. The method of any one of examples 18-21, further comprising, after transmitting the handover preparation information to the second RAN node: receiving from the second RAN node a handover command for the UE; and transmitting the handover command to the UE.

Example 23. The method of any one of examples 18-22, wherein transmitting the handover preparation information to the second RAN node includes transmitting to the second RAN node a handover request message that includes the handover preparation information.

Example 24. The method of any one of examples 18-23, wherein transmitting the handover preparation information to the second RAN node occurs via a core network (CN).

Example 25. The method of any one of examples 18-24, wherein: the first RAN node is a source base station in a handover procedure; and the second RAN node is a target base station in the handover procedure.

Example 26. The method of any one of examples 18-24, wherein: the first RAN node is a central unit (CU) of a distributed base station that is a source base station in a handover procedure; the second RAN node is a target base station in the handover procedure; and communicating with the UE operating in the RRC inactive state and communicating with the UE operating in the RRC connected state occur via a distributed unit (DU) of the distributed base station.

Example 27. A first radio access network (RAN) node comprising one or more processors and configured to perform the method of any one of examples 1-26.

Example 28. A method, performed by a central unit (CU) of a distributed base station in a radio access network (RAN), of managing configuration information, the method comprising: communicating with a user equipment (UE); and transmitting handover preparation information to a RAN node, wherein (i) when the RAN node is another base station or another central unit (CU), the handover preparation information includes a configuration for the UE to use when communicating with the RAN, and (ii) when the RAN node is a distributed unit (DU), the handover preparation information excludes the configuration.

Example 29. The method of example 28, wherein the RAN node is another base station or another CU and the handover preparation information includes the configuration.

Example 30. The method of example 28, wherein the RAN node is a DU and the handover preparation information excludes the configuration.

Example 31. The method of any one of examples 28-30, wherein the configuration is a small data transmission (SDT) configuration for use by the UE when the UE operates in a radio resource control (RRC) inactive state.

Example 32. The method of any one of examples 28-31, wherein transmitting the handover preparation information to the RAN node includes transmitting to the RAN node a handover request message that includes the handover preparation information.

Example 33. The method of any one of examples 28-32, wherein transmitting the handover preparation information to the RAN node occurs via a core network (CN).

Example 34. A central unit (CU) of a distributed base station, the CU comprising one or more processors and configured to perform the method of any one of examples 28-33.

The following description may be applied to the description above.

Generally speaking, description for one of the above figures can apply to another of the above figures. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “small data transmission” can be replaced by “early data transmission (EDT)” and “SDT” can be replaced by “EDT”, and vice versa. In some implementations, “small data transmission” can be replaced by “small data communication”, and vice versa. In some implementations, “stop” can be replaced by “suspend”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1.-6. (canceled)

7. A method, performed by a first radio access network (RAN) node, of managing configuration information for small data transmission (SDT) operation, the method comprising:
communicating with a user equipment (UE) operating in a radio resource control (RRC) inactive state using an SDT configuration;
transitioning the UE from the RRC inactive state to an RRC connected state;
communicating with the UE operating in the RRC connected state using a non-SDT configuration;
determining to hand over the UE to a second RAN node; and
in response to the determining, transmitting handover preparation information to the second RAN node, the handover preparation information excluding the SDT configuration.

8. The method of claim 7, wherein the handover preparation information includes the non-SDT configuration.

9. The method of claim 7, further comprising:
before communicating with the UE operating in the RRC inactive state, transmitting an RRC release message including the SDT configuration to the UE.

10. The method of claim 7, wherein transitioning the UE to the RRC connected state includes transmitting an RRC resume message to the UE.

11. The method of claim 7, further comprising, after transmitting the handover preparation information to the second RAN node:
receiving from the second RAN node a handover command for the UE; and
transmitting the handover command to the UE.

12. The method of claim 7, wherein transmitting the handover preparation information to the second RAN node includes transmitting to the second RAN node a handover request message that includes the handover preparation information.

13. The method of claim 7, wherein transmitting the handover preparation information to the second RAN node occurs via a core network (CN).

14. The method of claim 7, wherein:
the first RAN node is a source base station in a handover procedure; and
the second RAN node is a target base station in the handover procedure.

15. The method of claim 7, wherein:
the first RAN node is a central unit (CU) of a distributed base station that is a source base station in a handover procedure;
the second RAN node is a target base station in the handover procedure; and
communicating with the UE operating in the RRC inactive state and communicating with the UE operating in the RRC connected state occur via a distributed unit (DU) of the distributed base station.

16. A first radio access network (RAN) node comprising one or more processors and configured to:
communicate with a user equipment (UE) operating in a radio resource control (RRC) inactive state using a small data transmission (SDT) configuration;
transition the UE from the RRC inactive state to an RRC connected state;
communicate with the UE operating in the RRC connected state using a non-SDT configuration;
determine to hand over the UE to a second RAN node; and
in response to the determining, transmit handover preparation information to the second RAN node, the handover preparation information excluding the SDT configuration.

17. The first RAN node of claim 16, wherein the handover preparation information includes the non-SDT configuration.

18. The first RAN node of claim 16, wherein the first RAN node is further configured to:
before communicating with the UE operating in the RRC inactive state, transmit an RRC release message including the SDT configuration to the UE.

19. The first RAN node of claim 16, wherein transitioning the UE to the RRC connected state includes transmitting an RRC resume message to the UE.

20. The first RAN node of claim 16, wherein the first RAN node is further configured to, after transmitting the handover preparation information to the second RAN node:
receive from the second RAN node a handover command for the UE; and
transmit the handover command to the UE.

21. The first RAN node of claim 16, wherein transmitting the handover preparation information to the second RAN node includes transmitting to the second RAN node a handover request message that includes the handover preparation information.

22. The first RAN node of claim 16, wherein transmitting the handover preparation information to the second RAN node occurs via a core network (CN).

23. The first RAN node of claim 16, wherein:
the first RAN node is a source base station in a handover procedure; and
the second RAN node is a target base station in the handover procedure.

24. The first RAN node of claim 16, wherein:
the first RAN node is a central unit (CU) of a distributed base station that is a source base station in a handover procedure;
the second RAN node is a target base station in the handover procedure; and
communicating with the UE operating in the RRC inactive state and communicating with the UE operating in the RRC connected state occur via a distributed unit (DU) of the distributed base station.
